(19) United States
(12) Patent Application Publication
(10) Pub. No.: US 2026/0269147 A1
(43) Pub. Date: Sep. 10, 2026

(54) POLYVINYL ALCOHOL, LITHIUM SULFATE, AND 1-BUTYL-3-METHYLIMIDAZOLIUM TRIFLUOROMETHANESULFONATE GEL ELECTROLYTE

(71) Applicant: King Fahd University of Petroleum and Minerals, Dhahran (SA)

(72) Inventors: Abubakar Dahiru SHUAIBU, Dhahran (SA); Atif Saeed ALZAHRANI, Dhahran (SA); Md. Abdul AZIZ, Dhahran (SA)

(73) Assignee: King Fahd University of Petroleum and Minerals, Dhahran (SA)

(21) Appl. No.: 19/251,749

(22) Filed: Jun. 26, 2025

Related U.S. Application Data
(60) Provisional application No. 63/767,885, filed on Mar. 6, 2025.

(51) Int. Cl. H01G 11/62; H01G 11/34; H01G 11/60

(52) U.S. Cl. CPC H01G 11/62; H01G 11/34; H01G 11/60

(57) ABSTRACT

A gel electrolyte includes a polyvinyl alcohol, lithium sulfate, and a 1-butyl-3-methylimidazolium trifluoromethanesulfonate. The gel electrolyte is porous having an average pore diameter of 20 to 30 micrometers (μm) and an average pore wall thickness of 5 to 10 μm. The gel electrolyte comprises spherical nodules having a diameter of 5 to 500 μm.

### CROSS REFERENCE TO RELATED APPLICATION

This application claims the benefit of U.S. Provisional Application No. 63/767,885, filed Mar. 6, 2025, which is incorporated herein by reference in its entirety.

### STATEMENT REGARDING PRIOR DISCLOSURE BY THE INVENTORS

Aspects of the present disclosure are described in Shuaibu, A. D. et al., “Development and assessment of an innovative gel electrolyte using polyvinyl alcohol, lithium sulfate, and 1-butyl-3-methylimidazolium trifluoromethanesulfonate for advanced supercapacitor performance” published in Volume 92, Journal of Energy Storage, 2024, which is incorporated herein by reference in its entirety.

### STATEMENT OF ACKNOWLEDGEMENT

Support provided by King Fahd University of Petroleum and Minerals, Saudi Arabia, through Project EC213002 is gratefully acknowledged. Support provided by the Renewable Energy Technical Incubator under the Interdisciplinary Research Center for Sustainable Energy Systems, King Fahd University of Petroleum and Minerals, Saudi Arabia, through Project CREP2522 is gratefully acknowledged.

### BACKGROUND

### Technical Field

The present disclosure is directed towards a gel electrolyte, and more particularly, relates to a gel electrolyte comprising a polyvinyl alcohol, lithium sulfate, and a 1-butyl-3-methylimidazolium trifluoromethanesulfonate and a method of preparation thereof.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Supercapacitors are an emerging class of electrochemical energy storage devices known for their rapid charge/discharge rates, long cycle life, and high power density; however, their relatively low energy density compared to lithium-ion batteries presents a challenge for applications requiring higher energy storage. Current research is focused on enhancing specific capacitance and operating potential windows (OPW) of supercapacitors, which are factors influencing their energy density. Strategies such as using pseudocapacitive electrode materials and modifying electrolytes with redox-active additives have been explored to improve performance.

The electrolyte plays a role in determining the supercapacitor's ionic conductivity, electrochemical stability, and overall performance. While aqueous electrolytes are cost-effective, they are limited by a narrow OPW. Alternative solutions such as ionic liquids and organic electrolytes offer wider voltage windows but come with practical challenges such as high cost and flammability.

Gel electrolytes, particularly those based on polyvinyl alcohol (PVA), have gained attention for use in flexible supercapacitors due to their non-toxicity, ease of preparation, and low cost; however, PVA-based electrolytes often suffer from low ionic conductivity and poor mechanical strength. Incorporation of ionic liquids (ILs) into gel polymer electrolytes has shown to enhance both ionic conductivity and mechanical properties. Despite these improvements, development of a gel electrolyte that combines high ionic conductivity, a wide OPW, and increased mechanical properties for high-energy-density flexible supercapacitors has not yet been developed.

Accordingly, an objective of the present disclosure is to provide a composite gel electrolyte with enhanced ionic conductivity, mechanical strength, and expanded voltage window, enabling the development of flexible supercapacitors with improved energy density and cycling stability that over drawbacks and limitations known in the art.

### SUMMARY

In an exemplary embodiment, a gel electrolyte is described. The gel electrolyte includes a polyvinyl alcohol, lithium sulfate, and a 1-butyl-3-methylimidazolium trifluoromethanesulfonate. The gel electrolyte is porous having an average pore diameter of 20 to 30 micrometers (μm) and an average pore wall thickness of 5 to 10 μm. The gel electrolyte includes spherical nodules having a diameter of 5 to 500 μm.

In some embodiments, the gel electrolyte is made by a process including dissolving the polyvinyl alcohol in water to form a first solution, dissolving the lithium sulfate in water to form a second solution, mixing the first solution and the second solution to form a third solution, mixing the 1-butyl-3-methylimidazolium trifluoromethanesulfonate with the third solution at a temperature of 80 to 100° C. for 1 to 3 hours to form a mixture, and freezing and thawing the mixture to form the gel electrolyte.

In some embodiments, a weight ratio of the polyvinyl alcohol to the lithium sulfate to the 1-butyl-3-methylimidazolium trifluoromethanesulfonate is 1-3:0.5-1.5:1-3.

In some embodiments, the gel electrolyte includes carbon in an amount of 46 to 50 percent by weight (wt. %), oxygen in an amount of 34 to 38 wt. %, sulfur in an amount of 6 to 12 wt. %, and fluorine in an amount of 5 to 8 wt. % based on a total weight of the gel electrolyte.

In some embodiments, the gel electrolyte has a nanoindentation hardness of 2.4 to 3 megapascals (MPa).

In some embodiments, the gel electrolyte has an elastic modulus of 0.04 to 0.08 gigapascals (GPa).

In some embodiments, the gel electrolyte has a glass transition temperature of 140 to 160° C.

In some embodiments, the gel electrolyte has an ionic conductivity of 12 to 15 milliSiemens per centimeter (mS/cm) at a temperature of 25° C.

In some embodiments, the gel electrolyte has an ionic conductivity of 29 to 34 mS/cm at a temperature of 80° C.

In some embodiments, a symmetric supercapacitor is described. The symmetric supercapacitor includes a positive electrode and a negative electrode including a date stone activated carbon mixture coated on stainless steel and the gel electrolyte. The gel electrolyte separates the positive electrode and the negative electrode. The positive electrode, the gel electrolyte, and the negative electrode are enclosed in a coin cell.

In some embodiments, the symmetric supercapacitor has an operating potential window of 4.3 to 4.7 volts (V).

In some embodiments, the symmetric supercapacitor has a specific capacitance of 80 to 85 farads per gram (F/g) over an operating potential window of 2 V via cyclic voltammetry.

In some embodiments, the symmetric supercapacitor has a specific capacitance of 110 to 115 F/g at a scan rate of 10 millivolts per second (mV/s) via cyclic voltammetry.

In some embodiments, the symmetric supercapacitor has a specific capacitance of 115 to 120 F/g at a current density of 0.5 amperes per gram (A/g) via galvanostatic charge/discharge tests.

In some embodiments, the symmetric supercapacitor has a specific capacitance of 55 to 60 F/g at a current density of 5 A/g via galvanostatic charge/discharge tests.

In some embodiments, the symmetric supercapacitor has a bulk resistance of 4.5 to 5.5 ohms (Q).

In some embodiments, the symmetric supercapacitor has a bulk resistance of 6.5 to 7Ω after 1000 charge and discharge cycles.

In some embodiments, the symmetric supercapacitor has an energy density of 60 to 70 watt-hours per kilogram (Wh/kg) at a power density of 500 watts per kilogram (W/kg).

In some embodiments, the symmetric supercapacitor has a capacitance retention of 85 to 90% of an initial capacitance after 10,000 galvanostatic charge/discharge cycles at a current load of 10 A/g.

In some embodiments, the symmetric supercapacitor has a coulombic efficiency of at least 98% after 10,000 galvanostatic charge/discharge cycles at a current load of 10 A/g.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flow chart of a process of preparing a gel electrolyte, according to certain embodiments.

FIG. 1B is a schematic diagram of a process of preparing the gel electrolyte, according to certain embodiments.

FIG. 2A is a field emission scanning electron microscopy (FESEM) micrograph of PVA-Li₂SO₄ with a scale of 500 micrometers (μm), according to certain embodiments.

FIG. 2B is an FESEM micrograph of PVA-Li₂SO₄ with a scale of 100 μm, according to certain embodiments.

FIG. 2C is an energy dispersive X-ray spectroscopy (EDS) spectrum of PVA-Li₂SO₄, according to certain embodiments.

FIG. 2D is an FESEM micrograph of PVA-Li₂SO₄-IL with a scale of 500 μm, according to certain embodiments.

FIG. 2E is an FESEM micrograph of PVA-Li₂SO₄-IL with a scale of 100 μm, according to certain embodiments.

FIG. 2F is an EDS spectrum of PVA-Li₂SO₄-IL, according to certain embodiments.

FIG. 3A depicts elemental mapping of carbon (C) in PVA-Li₂SO₄, according to certain embodiments.

FIG. 3B depicts elemental mapping of oxygen (O) in PVA-Li₂SO₄, according to certain embodiments.

FIG. 3C depicts elemental mapping of sulfur (S) in PVA-Li₂SO₄, according to certain embodiments.

FIG. 3D depicts elemental mapping of C in PVA-Li₂SO₄-IL, according to certain embodiments.

FIG. 3E depicts elemental mapping of O in PVA-Li₂SO₄-IL, according to certain embodiments.

FIG. 3F depicts elemental mapping of S in PVA-Li₂SO₄-IL, according to certain embodiments.

FIG. 3G depicts elemental mapping of fluorine (F) in PVA-Li₂SO₄-IL, according to certain embodiments.

FIG. 4 depicts X-ray diffraction (XRD) patterns of gel electrolytes Li₂SO₄, PVA, PVA-Li₂SO₄, and PVA-Li₂SO₄-IL, according to certain embodiments.

FIG. 5A depicts a linear sweep voltammetry (LSV) spectrum of PVA-Li₂SO₄, according to certain embodiments.

FIG. 5B depicts an LSV spectrum of PVA-Li₂SO₄-IL, according to certain embodiments.

FIG. 5C depicts electrochemical impedance spectroscopy (EIS) Nyquist plots of PVA-Li₂SO₄-IL at room temperature, 40° C., 60° C., 80° C., and 100° C., according to certain embodiments.

FIG. 5D depicts magnified EIS Nyquist plots of PVA-Li₂SO₄-IL at room temperature, 40° C., 60° C., 80° C., and 100° C., according to certain embodiments.

FIG. 5E depicts ionic conductivity of PVA-Li₂SO₄-IL at room temperature, 40° C., 60° C., 80° C., and 100° C., according to certain embodiments.

FIG. 5F depicts EIS Nyquist plots of PVA-Li₂SO₄-IL with varying Li₂SO₄ content, according to certain embodiments.

FIG. 5G depicts magnified EIS Nyquist plots of PVA-Li₂SO₄-IL with varying Li₂SO₄ content, according to certain embodiments.

FIG. 5H depicts ionic conductivity of PVA-Li₂SO₄-IL with varying Li₂SO₄ content, according to certain embodiments.

FIG. 6A is load-indentation depth curve of PVA-Li₂SO₄ and PVA-Li₂SO₄-IL, according to certain embodiments.

FIG. 6B is a thermogravimetric analysis (TGA) curve of PVA-Li₂SO₄ and PVA-Li₂SO₄-IL, according to certain embodiments.

FIG. 6C is a differential scanning calorimetry (DSC) thermogram of PVA-Li₂SO₄ and PVA-Li₂SO₄-IL, according to certain embodiments.

FIG. 7A depicts cyclic voltammograms (CVs) of PVA-Li₂SO₄-based symmetric supercapacitors at operating potential windows (OPWs) of 1.0 volt (V), 1.2 V, 1.4 V, 1.6 V, 1.8 V, and 2.0 V and a constant scan rate of 50 millivolts seconds (mV/s), according to certain embodiments.

FIG. 7B depicts CVs of PVA-Li₂SO₄-IL-based symmetric supercapacitors at OPWs of 1 V, 1.2 V, 1.4 V, 1.6 V, 1.8 V, and 2.0 V, according to certain embodiments.

FIG. 7C depicts CVs of PVA-Li₂SO₄-based symmetric supercapacitors at scan rates of 10 millivolts per second (mV/s), 20 mV/s, 50 mV/s, 80 mV/s, 100 mV/s, and 150 mV/s, according to certain embodiments.

FIG. 7D depicts CVs of PVA-Li₂SO₄-IL-based symmetric supercapacitors at various scan rates of 10 mV/s, 20 mV/s, 50 mV/s, 80 mV/s, 100 mV/s, and 150 mV/s, according to certain embodiments.

FIG. 8A depicts galvanostatic charge-discharge (GCD) curves of PVA-Li₂SO₄-based supercapacitors at OPWs of 1 V, 1.2 V, 1.4 V, 1.6 V, 1.8 V, and 2.0 V and at a current density of 5 amperes per gram (A/g), according to certain embodiments.

FIG. 8B depicts GCD curves of PVA-Li₂SO₄-IL-based supercapacitors at OPWs of 1 V, 1.2 V, 1.4 V, 1.6 V, 1.8 V, and 2.0 V and at a current density of 5 A/g, according to certain embodiments.

FIG. 8C depicts GCD curves of PVA-Li₂SO₄-based supercapacitors at current densities of 0.5 A/g, 1 A/g, 2 A/g, 3 A/g, 4 A/g, and 5 A/g, according to certain embodiments.

FIG. 8D depicts GCD curves of PVA-Li₂SO₄-IL-based supercapacitors at current densities of 0.5 A/g, 1 A/g, 2 A/g, 3 A/g, 4 A/g, and 5 A/g, according to certain embodiments.

FIG. 9A depicts Nyquist plots comparing EIS response between PVA-Li₂SO₄-based and PVA-Li₂SO₄-IL-based symmetric supercapacitor devices, according to certain embodiments.

FIG. 9B depicts EIS Nyquist plots of a PVA-Li₂SO₄-IL-based symmetric supercapacitor device before and after 1000 GCD cycles, according to certain embodiments.

FIG. 9C depicts Ragone plots of PVA-Li₂SO₄-based and PVA-Li₂SO₄-IL-based symmetric supercapacitor devices, according to certain embodiments.

FIG. 9D depicts cycling performance of the PVA-Li₂SO₄-IL-based symmetric supercapacitor at 10 A/g, according to certain embodiments.

FIG. 9E depicts the last 10 cycles of the cycling performance of the PVA-Li₂SO₄-IL-based symmetric supercapacitor at 10 A/g, according to certain embodiments.

FIG. 10 is a schematic of a coin cell assembly for the PVA-Li₂SO₄-IL-based symmetric supercapacitor, according to certain embodiments.

FIG. 11 is a radar plot comparing potential window, ionic conductivity, energy density, power density, and stability of the PVA-Li₂SO₄-IL-based symmetric supercapacitor and other supercapacitors in literature, according to certain embodiments.

### DETAILED DESCRIPTION

When describing the present disclosure, the terms used are to be construed in accordance with the following definitions, unless a context dictates otherwise.

Embodiments of the present disclosure will now be described more fully hereinafter with reference to the accompanying drawings wherever applicable, in that some, but not all, embodiments of the disclosure are shown.

In the drawings, like reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

A weight percent of a component, unless specifically stated to the contrary, is based on the total weight of the formulation or composition in which the component is included. For example, if a particular element or component in a composition or article is said to have 5 weight percent (wt. %), it is understood that this percentage is in relation to a total compositional percentage of 100%.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium, and isotopes of carbon include ¹³C and ¹⁴C.

Isotopically-labelled compounds of the disclosure may generally be prepared by conventional techniques known to those skilled in the art or by processes analogous to those described herein, using an appropriate isotopically-labelled reagent in place of the non-labelled reagent otherwise employed.

As used herein, the term “amount” refers to the level, mass, or concentration of one or more reactants, catalysts, or materials present in a reaction mixture.

As used herein, the term “gel electrolyte” refers to a polymer matrix that retains an ionic liquid or aqueous solution capable of conducting ions. The polymer matrix provides structural integrity to the electrolyte composition, thereby facilitating the transport of ions within the gel while maintaining a substantially stable and uniform phase. The gel electrolyte may be utilized in electrochemical devices such as batteries, supercapacitors, fuel cells, and the like. It serves to enhance ionic conductivity and stability under operational conditions. The gel electrolyte is a semi-solid substance that facilitates ionic conduction between positive and negative electrodes in a supercapacitor, while providing structural stability and safety.

As used herein, the term “pore diameter” refers to an average width or size of void spaces (pores) within a material, typically measured in nanometers (nm) or angstroms (Å). It is a parameter used in characterizing texture and permeability of porous materials, which may influence their adsorption, filtration, and/or catalytic properties. Pore diameter may be determined using methods such as nitrogen adsorption or mercury intrusion, which provide insights into a material's ability to absorb and/or interact with molecules of specific sizes.

As used herein, the term “nanoindentation hardness” refers to a measurement of a material's resistance to localized plastic deformation when subjected to an indenter at a nanoscale level, typically quantified in terms of indentation depth or force.

As used herein, the term “elastic modulus” refers to a material's ability to resist deformation under applied stress, specifically the ratio of stress to strain in the elastic region of the material's stress-strain curve, often expressed in Pascals (Pa).

As used herein, the term “glass transition temperature” refers to the temperature range at which a polymer or glass transitions from a hard, glassy state to a softer, rubbery state, typically associated with a change in heat capacity.

As used herein, the term “ionic conductivity” refers to the ability of a material, typically an electrolyte, to conduct ions under an applied electric field, usually expressed in S/cm (Siemens per centimeter).

As used herein, the term “operating potential window” refers to the range of electrical potentials within which a material, such as an electrolyte or electrode, can operate without undergoing decomposition or unwanted side reactions.

As used herein, the term “specific capacitance” refers to the capacitance per unit mass or volume of a material, typically expressed in farads per gram (F/g) or farads per cubic centimeter (F/cm³).

As used herein, the term “current density” refers to the amount of electric current flowing per unit cross-sectional area of a material or device, typically expressed in amperes per square centimeter (A/cm²).

As used herein, the term “galvanostatic charge/discharge tests” refers to electrochemical tests performed under constant current conditions, where the material is charged and/or discharged at a fixed current and a voltage response is measured.

As used herein, the term “bulk resistance” refers to a total resistance of a material or device, excluding contributions from interfaces, such as contact resistance, typically expressed in ohms (Q).

As used herein, the term “energy density” refers to an amount of energy stored per unit mass or volume of a material or device, often expressed in watt-hours per kilogram (Wh/kg) or watt-hours per liter (Wh/L).

As used herein, the term “capacitance retention” refers to an ability of a material or device to maintain a portion of its initial capacitance over a specified number of charge/discharge cycles.

As used herein, the term “coulombic efficiency” refers to a ratio of charge returned during discharge to charge applied during charge, typically expressed as a percentage, indicating reversibility of charge storage.

As used herein, the term “room temperature” refers to a temperature range of 25±3 degrees Celsius (° C.).

As used herein, the term “symmetric supercapacitor” refers to a type of supercapacitor in which both the positive and negative electrodes are made of the same material, leading to symmetrical electrochemical characteristics.

As used herein, the term “positive electrode” (also known as an anode) refers to an electrode in a supercapacitor that undergoes oxidation and discharges positive ions during charge.

As used herein, the term “negative electrode” (also known as a cathode) refers to an electrode in a supercapacitor that undergoes reduction and discharges negative ions during charge.

As used herein, the term “date stone activated carbon mixture” refers to a composite material created by activating carbon derived from date stones. The date stone activated carbon mixture is used as an active material for electrodes due to its high surface area and conductivity.

As used herein, the term “coated on stainless steel” refers to a process of applying a layer of the date stone activated carbon mixture onto a stainless-steel substrate to form the electrode material.

As used herein, the term “separates” refers to a function of the gel electrolyte to physically and electrically isolate the positive and negative electrodes to prevent short-circuiting while enabling ionic flow for charge and discharge cycles.

As used herein, the term “coin cell” refers to a small, flat, cylindrical container used to house components of the supercapacitor, including the electrodes and electrolyte.

Aspects of the present disclosure are directed towards a gel electrolyte, PVA-Li₂SO₄-IL, formulated from polyvinyl alcohol, lithium sulfate, and an ionic liquid. The electrolyte is synthesized through solution casting and a freezing-thawing process. Incorporating the ionic liquid enhances ionic conductivity and introduces pseudo capacitance to the gel electrolyte.

Characterization of the gel electrolyte reveals good mechanical strength, crystallinity, and thermal stability. When used in a symmetric supercapacitor with date stone-derived activated carbon electrodes, the gel electrolyte demonstrates high energy and power density, along with excellent cycling stability. The PVA-Li₂SO₄-IL gel electrolyte is a good candidate for high-performance energy storage systems.

A gel electrolyte is described. The gel electrolyte includes a polyvinyl alcohol, lithium sulfate, and a 1-butyl-3-methylimidazolium trifluoromethanesulfonate. In a preferred embodiment, the polyvinyl alcohol is polyvinyl alcohol (PVA), [C₂H₄O]ₙ. In a preferred embodiment, the 1-butyl-3-methylimidazolium trifluoromethanesulfonate is 1-butyl-3-methylimidazolium trifluoromethanesulfonate.

In other embodiments, alternatives including, but not limited to, polyethylene glycol, polyacrylic acid, polyvinyl pyrrolidone, polymethyl methacrylate, polyurethane, polycaprolactone, polylactic acid, polyethylene oxide, polyhydroxyethyl methacrylate, polysaccharides, polypropylene oxide, polyvinylidene fluoride, polyacrylamide, polyphenylene oxide, polystyrene, polyvinyl acetate, polybutadiene, polytetrafluoroethylene, polylactic-co-glycolic acid, polyimide, polyethylene terephthalate, polyamide, polyetherimide, polyvinylbutyral, polycarbonates, polyhydroxypropyl methacrylate, poly(diallyl dimethyl ammonium chloride), polysiloxanes, polysulfones, polythiophene, polylactide, polytrimethylene carbonate, polyborates, polycaprolactam, polymerized ionic liquids, polyphosphazenes, polyglutamic acid, polyhydroxypropyl cellulose, polypropylenes, polyisoprene, poly(p-phenylene sulfide), poly(ethylene-co-vinyl acetate), poly(n-butyl acrylate), poly(2-hydroxyethyl methacrylate), polycatechins, polyvinyl acetate phthalate, poly(ethylene glycol)-polypropylene glycol block copolymers, polycarboxylates, poly(methyl acrylate), polybutyl methacrylate, poly(styrene-butadiene-styrene), polyfluoroethylene, polycarbonate-urethane, polysubstituted polyphenylene, polytetrahydrofuran, a combination thereof, and the like may be used in place of or in combination with the polyvinyl alcohol.

In other embodiments, alternatives for lithium sulfate may include, but are not limited to, lithium hexafluorophosphate, lithium chloride, lithium perchlorate, lithium bis(trifluoromethanesulfonyl)imide, sodium sulfate, potassium sulfate, magnesium sulfate, calcium sulfate, lithium tetrafluoroborate, sodium bis(trifluoromethanesulfonyl)imide, potassium bis(trifluoromethanesulfonyl)imide, lithium nitrate, sodium nitrate, potassium nitrate, lithium carbonate, sodium carbonate, potassium carbonate, ammonium sulfate, potassium bisulfate, magnesium chloride, calcium chloride, potassium chloride, sodium bisulfate, lithium iodide, sodium iodide, potassium iodide, lithium bromide, sodium bromide, potassium bromide, lithium acetate, sodium acetate, potassium acetate, lithium formate, sodium formate, potassium formate, lithium bisphosphate, sodium bisphosphate, potassium bisphosphate, lithium ferrocyanide, potassium ferrocyanide, sodium ferrocyanide, sodium tetraborate, potassium tetraborate, magnesium acetate, calcium acetate, potassium pyrophosphate, lithium pyrophosphate, sodium pyrophosphate, potassium oxalate, lithium oxalate, sodium oxalate, magnesium oxalate, calcium oxalate, potassium tartrate, lithium tartrate, sodium tartrate, lithium sulfate monohydrate, sodium sulfate anhydrous, potassium sulfate anhydrous, a combination thereof, and the like.

In other embodiments, alternatives including, but not limited to, 1-ethyl-3-methylimidazolium tetrafluoroborate, 1-butyl-1-methylpyrrolidinium bis(trifluoromethanesulfonyl)imide, 1-octyl-3-methylimidazolium hexafluorophosphate, 1-butyl-3-methylimidazolium chloride, 1-butyl-3-methylimidazolium bromide, 1-ethyl-3-methylimidazolium chloride, 1-ethyl-3-methylimidazolium bromide, 1-hexyl-3-methylimidazolium tetrafluoroborate, 1-butyl-3-methylimidazolium iodide, 1-methyl-3-ethylimidazolium trifluoromethanesulfonate, 1-butyl-3-methylpyridinium tetrafluoroborate, 1-butyl-3-methylimidazolium acetate, 1-ethyl-3-methylimidazolium acetate, 1-butyl-1-methylpyrrolidinium chloride, 1-butyl-3-methylimidazolium bis(trifluoromethanesulfonyl)imide, 1-octyl-3-methylimidazolium trifluoromethanesulfonate, 1-butyl-4-methylimidazolium hexafluorophosphate, 1-butyl-3-methylimidazolium thiocyanate, 1-methyl-3-ethylpyridinium trifluoromethanesulfonate, 1-butyl-3-methylpyridinium bis(trifluoromethanesulfonyl)imide, 1-ethyl-3-methylpyridinium trifluoromethanesulfonate, 1-hexyl-3-methylpyridinium trifluoromethanesulfonate, 1-ethyl-4-methylimidazolium bis(trifluoromethanesulfonyl)imide, 1-butyl-1-methylimidazolium bromide, 1-butyl-1-methylpyrrolidinium bis(trifluoromethanesulfonyl)imide, 1-butyl-3-methylpyridinium chloride, 1-butyl-3-methylpyridinium bromide, 1-octyl-1-methylpyridinium tetrafluoroborate, 1-octyl-1-methylpyridinium bis(trifluoromethanesulfonyl)imide, 1-butyl-1-methylpyridinium iodide, 1-ethyl-1-methylimidazolium bis(trifluoromethanesulfonyl)imide, 1-butyl-3-methylimidazolium bis(heptafluorobutylsulfonyl)imide, 1-butyl-3-methylimidazolium perfluorobutanesulfonate, a combination thereof, and the like may be used in place of or in combination with 1-butyl-3-methylimidazolium trifluoromethanesulfonate.

The gel electrolyte is porous having an average pore diameter of 20 to 30 micrometers (μm), preferably 21 to 29 μm, preferably 22 to 28 μm, preferably 23 to 27 μm, more preferably 24 to 26 μm, and yet more preferably about 25 μm and an average pore wall thickness of 5 to 10 μm, preferably 5.5 to 9.8 μm, preferably 6 to 9.5 μm, preferably 6.5 to 9.3 μm, preferably 7 to 9 μm, preferably 7.5 to 8.8 μm, more preferably 7.8 to 8.5 μm, and yet more preferably about 8 μm. The gel electrolyte includes spherical nodules having a diameter of 5 to 500 μm, preferably 10 to 490 μm, preferably 20 to 480 μm, preferably 25 to 475 μm, preferably 50 to 450 μm, preferably 75 to 425 μm, preferably 100 to 400 μm, preferably 125 to 375 μm, preferably 150 to 350 μm, preferably 175 to 325 μm, preferably 200 to 300 μm, and preferably 225 to 275 μm.

In alternative embodiments, the gel electrolyte may have other morphologies such as fibrous structures, lamellar layers, dendritic formations, honeycomb (porous) structures, film-like (thin film) layers, microsphere (spherical cluster) aggregates, rod-like shapes, network-like 3D scaffolds, clustered particles, nanosheets, nanowires, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanofloweres, cylindrical forms, coiled structures, tetrahedral shapes, mosaic arrangements, vesicular formations, a combination thereof, and the like.

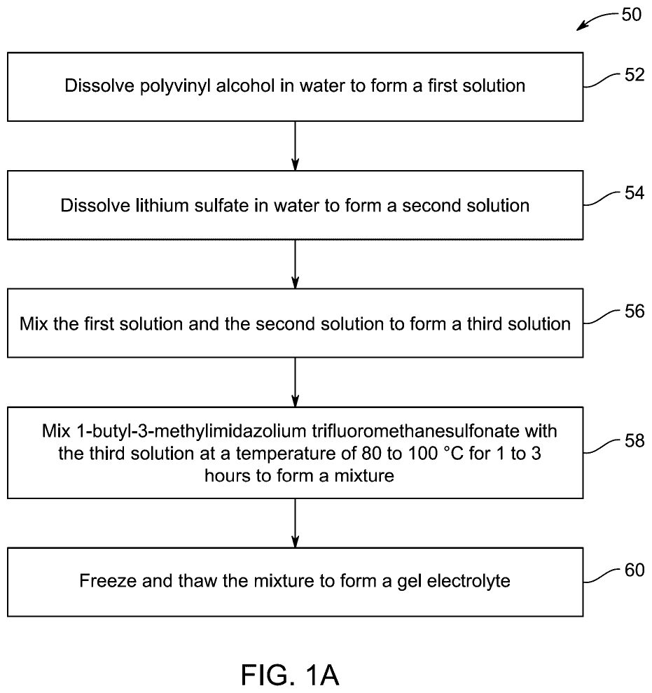

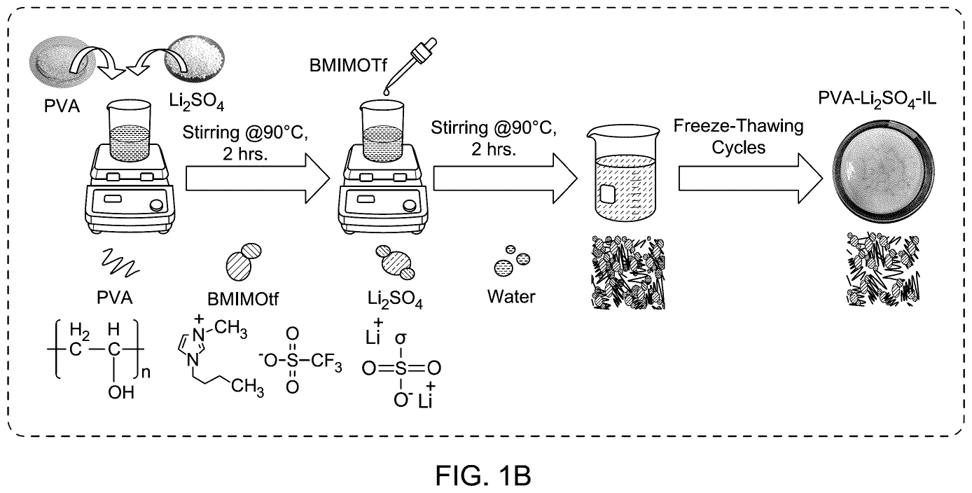

FIG. 1A illustrates a flow chart of a process 50 of preparing the gel electrolyte. The order in which the process 50 is described is not intended to be construed as a limitation, and any number of the described method steps can be combined in any order to implement the process 50. Additionally, individual steps may be removed or skipped from the process 50 without departing from the spirit and scope of the present disclosure.

At step 52, the process 50 includes dissolving the polyvinyl alcohol in water to form a first solution. In some embodiments, the water may be tap water, distilled water, bi-distilled water, deionized water, deionized distilled water, reverse osmosis water, hard water, fresh water, brine/salt water, a combination thereof, and the like. In a preferred embodiment, the water is deionized water. Dissolving can be done by methods such as stirring, heating, ultrasonic dissolution, magnetic stirring under reduced pressure, high shear mixing, batch dissolution with stirring at elevated temperature, dissolution by adding solvent in portions, dissolution via pH adjustment, freeze-thaw, a combination thereof, and the like. In some embodiments, any other methods may be included which are used or known in the art.

At step 54, the process 50 includes dissolving the lithium sulfate in water to form a second solution. The water is preferably deionized water. Dissolving can be done by methods such as stirring, heating, ultrasonic dissolution, magnetic stirring under reduced pressure, high shear mixing, batch dissolution with stirring at elevated temperature, dissolution by adding solvent in portions, dissolution via pH adjustment, freeze-thaw, a combination thereof, and the like. In some embodiments, any other methods may be included which are used or known in the art.

At step 56, the process 50 includes mixing the first solution and the second solution to form a third solution. In some embodiments, the mixing may be done by stirring, swirling, sonicating, a combination thereof, and the like. In a preferred embodiment, the mixing is done by stirring.

At step 58, the process 50 includes mixing the 1-butyl-3-methylimidazolium trifluoromethanesulfonate with the third solution at a temperature of 80 to 100° C., preferably 85 to 95° C., and preferably about 90° C. for 1 to 3 hours, preferably 1.5 to 2.5 hours, and preferably about 2 hours to form a mixture. Stirring, in this process, facilitates uniform dispersion and homogeneous mixing of the lithium sulfate, polyvinyl alcohol, and 1-butyl-3-methylimidazolium trifluoromethanesulfonate, thereby promoting effective integration of the ionic liquid with the polymer and salt components. Stirring promotes dissolution and interaction of materials, allowing for the formation of a consistent, uniform gel. Additionally, continuous agitation aids in the controlled evaporation of excess solvent, resulting in a reduction of the solution volume to approximately half of its original volume, thereby increasing the viscosity.

At step 60, the process 50 includes freezing and thawing the mixture to form the gel electrolyte. Freezing and thawing the mixture induces self-assembly and polymer network formation, resulting in a stable gel electrolyte. The process involves freezing the mixture at temperatures of −40 to −20° C., preferably −35 to −25° C., and preferably about −30° C., followed by thawing at room temperature, which promotes alignment and crosslinking of polymer chains.

In some embodiments, a weight ratio of the polyvinyl alcohol to the lithium sulfate to the 1-butyl-3-methylimidazolium trifluoromethanesulfonate is 1-3:0.5-1.5:1-3, preferably 1.5-2.5:0.8-1.2:1.5-2.5, and more preferably about 2:1:2.

In some embodiments, the gel electrolyte includes carbon in an amount of 46 to 50 percent by weight (wt. %), preferably 46.5 to 49.5 wt. %, preferably 47 to 49 wt. %, preferably 47.5 to 48.5 wt. %, preferably 47.8 to 48.3 wt. %, more preferably 48 to 48.2 wt. %, and yet more preferably about 48.1 wt. %, oxygen in an amount of 34 to 38 wt. %, preferably 34.5 to 37.5 wt. %, preferably 35 to 37 wt. %, more preferably 36 to 36.5 wt. %, and yet more preferably about 36.4 wt. %, sulfur in an amount of 6 to 12 wt. %, preferably 6.5 to 11.5 wt. %, preferably 7 to 11 wt. %, preferably 7.5 to 10.5 wt. %, preferably 7.8 to 10.2 wt. %, preferably 8 to 10 wt. %, preferably 8.2 to 9.8 wt. %, preferably 8.5 to 9.5 wt. %, preferably 8.7 to 9.3 wt. %, more preferably 8.9 to 9.1 wt. %, and yet more preferably about 9 wt. %, and fluorine in an amount of 5 to 8 wt. %, preferably 5.5 to 7.5 wt. %, preferably 6 to 7.4 wt. %, preferably 6.1 to 7.2 wt. %, preferably 6.2 to 7 wt. %, preferably 6.3 to 6.9 wt. %, preferably 6.4 to 6.8 wt. %, more preferably 6.5 to 6.7 wt. %, and yet more preferably about 6.6 wt. % based on a total weight of the gel electrolyte.

In some embodiments, the gel electrolyte has a nanoindentation hardness of 2.4 to 3 megapascals (MPa), preferably 2.5 to 2.9 MPa, more preferably 2.6 to 2.8 MPa, and yet more preferably about 2.7 MPa.

In some embodiments, the gel electrolyte has an elastic modulus of 0.04 to 0.08 gigapascals (GPa), preferably 0.045 to 0.075 GPa, preferably 0.05 to 0.07 GPa, preferably 0.052 to 0.065 GPa, preferably 0.055 to 0.06 GPa, more preferably 0.056 to 0.058 GPa, and yet more preferably about 0.057 GPa.

In some embodiments, the gel electrolyte has a glass transition temperature of 140 to 160° C., preferably 141 to 159° C., preferably 142 to 158° C., preferably 143 to 157° C., preferably 144 to 156° C., preferably 145 to 155° C., preferably 146 to 154° C., preferably 147 to 153° C., preferably 148 to 152° C., more preferably 149 to 151° C., and yet more preferably about 150° C.

In some embodiments, the gel electrolyte has an ionic conductivity of 12 to 15 milliSiemens per centimeter (mS/cm), preferably 12.1 to 14.9 mS/cm, preferably 12.2 to 14.8 mS/cm, preferably 12.3 to 14.7 mS/cm, preferably 12.4 to 14.6 mS/cm, preferably 12.5 to 14.5 mS/cm, preferably 12.6 to 14.4 mS/cm, preferably 12.7 to 14.3 mS/cm, preferably 12.8 to 14.2 mS/cm, preferably 12.9 to 14.1 mS/cm, preferably 13 to 14 mS/cm, preferably 13.1 to 13.8 mS/cm, more preferably 13.2 to 13.5 mS/cm, and yet more preferably about 13.32 mS/cm at a temperature of 25° C.

In some embodiments, the gel electrolyte has an ionic conductivity of 29 to 34 mS/cm, preferably 29.5 to 33.5 mS/cm, preferably 30 to 33 mS/cm, preferably 30.5 to 32.5 mS/cm, preferably 31 to 32 mS/cm, preferably 31.1 to 32.5 mS/cm, preferably 31.2 to 32 mS/cm, preferably 31.3 to 31.8 mS/cm, more preferably 31.4 to 31.5 mS/cm, and yet more preferably about 31.42 mS/cm at a temperature of 80° C.

In some embodiments, a symmetric supercapacitor comprising a positive electrode and a negative electrode including a date stone activated carbon mixture coated on stainless steel and the gel electrolyte is described. In some embodiments, the gel electrolyte separates the positive electrode and the negative electrode. In some embodiments, the positive electrode, the gel electrolyte, and the negative electrode are enclosed in a coin cell. In other embodiments, the positive electrode, the gel electrolyte, and the negative electrode may be enclosed in any electrolytic cell known in the art.

In some embodiments, the symmetric supercapacitor has an operating potential window (OWP) of 4.3 to 4.7 volts (V), preferably 4.35 to 4.65 V, preferably 4.4 to 4.6 V, more preferably 4.45 to 4.55 V, and yet more preferably about 4.5 V.

In some embodiments, the symmetric supercapacitor has a specific capacitance of 80 to 85 farads per gram (F/g), preferably 80.5 to 84.5 F/g, preferably 81 to 84 F/g, preferably 81.5 to 83.5 F/g, preferably 81.8 to 83.2 F/g, preferably 82 to 83 F/g, preferably 82.1 to 82.9 F/g, preferably 82.3 to 82.8 F/g, preferably 82.4 to 82.7 F/g, more preferably 82.5 to 82.6 F/g, and yet more preferably about 82.6 F/g over an operating potential window of 2 V via cyclic voltammetry.

In some embodiments, the symmetric supercapacitor has a specific capacitance of 110 to 115 F/g, preferably 110.5 to 114.5 F/g, preferably 111 to 114 F/g, preferably 111.5 to 113.5 F/g, preferably 112 to 113 F/g, preferably 112.2 to 112.9 F/g, preferably 112.5 to 113.8 F/g, more preferably 112.6 to 112.7 F/g, and yet more preferably about 112.69 F/g at a scan rate of 10 millivolts per second (mV/s) via cyclic voltammetry.

In some embodiments, the symmetric supercapacitor has a specific capacitance of 115 to 120 F/g, preferably 115.5 to 119.5 F/g, preferably 116 to 119 F/g, preferably 116.5 to 118.5 F/g, preferably 116.8 to 118.2 F/g, preferably 117 to 118 F/g, preferably 117.1 to 117.5 F/g, more preferably 117.2 to 117.3 F/g, and yet more preferably about 117.25 F/g at a current density of 0.5 amperes per gram (A/g) via galvanostatic charge/discharge tests.

In some embodiments, the symmetric supercapacitor has a specific capacitance of 55 to 60 F/g, preferably 55.5 to 59.5 F/g, preferably 56 to 59 F/g, preferably 56.5 to 58.5 F/g, preferably 56.8 to 58.2 F/g, preferably 57 to 58 F/g, preferably 57.2 to 57.8 F/g, preferably 57.3 to 57.7 F/g, more preferably 57.4 to 57.6 F/g, and yet more preferably about 57.5 F/g at a current density of 5 A/g via galvanostatic charge/discharge tests.

In some embodiments, the symmetric supercapacitor has a bulk resistance of 4.5 to 5.5 ohms (Ω), preferably 4.6 to 5.3Ω, preferably 4.7 to 5.1Ω, more preferably 4.8 to 5Ω, and yet more preferably about 4.9Ω.

In some embodiments, the symmetric supercapacitor has a bulk resistance of 6.5 to 7 (Q), preferably 6.55 to 6.95Ω, preferably 6.6 to 6.9Ω, preferably 6.65 to 6.88Ω, preferably 6.7 to 6.85Ω, more preferably 6.75 to 6.83Ω, and yet more preferably about 6.8Ω after 1000 charge and discharge cycles.

In some embodiments, the symmetric supercapacitor has an energy density of 60 to 70 watt-hours per kilogram (Wh/kg), preferably 61 to 69 Wh/kg, preferably 62 to 68 Wh/kg, preferably 63 to 67 Wh/kg, preferably 64 to 66 Wh/kg, preferably 64.5 to 65.5 Wh/kg, preferably 64.8 to 65.4 Wh/kg, preferably 65 to 65.3 Wh/kg, more preferably 65.1 to 65.2 Wh/kg, and yet more preferably about 65.15 Wh/kg at a power density of 500 watts per kilogram (W/kg).

In some embodiments, the symmetric supercapacitor has a capacitance retention of 85 to 90%, preferably 86 to 89.8%, preferably 87 to 89.6%, preferably 87.5 to 89.4%, preferably 88 to 89.2%, more preferably 88.5 to 89%, and yet more preferably about 88.7% of an initial capacitance after 10,000 galvanostatic charge/discharge cycles at a current load of 10 A/g.

In some embodiments, the symmetric supercapacitor has a coulombic efficiency of at least 98%, preferably at least 98.5%, preferably at least 99%, preferably at least 99.5%, and preferably about 100% after 10,000 galvanostatic charge/discharge cycles at a current load of 10 A/g.

### EXAMPLES

The following examples describe and demonstrate a gel electrolyte comprising a polyvinyl alcohol, lithium sulfate, and a 1-butyl-3-methylimidazolium trifluoromethanesulfonate. The examples are provided solely for illustration and are not to be construed as limitations of the present disclosure, as many variations thereof are possible without departing from the spirit and scope of the present disclosure.

### Example 1: Materials

Date stones were obtained from a local farm in Dhahran, Saudi Arabia. Potassium hydroxide (KOH) pellets, hydrochloric acid (HCl), Li₂SO₄, polyvinyl alcohol (PVA), and 1-butyl-3-methylimidazolium trifluoromethane sulfonate (BMIM OTf), were obtained from Sigma-Aldrich. N-methyl pyrrolidone (NMP), polyvinylidene fluoride (PVDF), carbon black, and 304 stainless-steel foils were purchased from Materials Technology, Inc. (MTI) corporation. Nitrogen gas of high purity was used to synthesize the activated carbon.

### Example 2: Preparation of the Gel Electrolyte (PVA-Li₂SO₄-IL)

Synthesis of the gel electrolyte involved a straightforward solution casting technique, complemented by a freeze-thawing process. Initially, 2 grams (g) of PVA was dissolved in 20 milliliters (mL) of deionized water. This mixture was then heated to 90° C. under strong stirring until it formed a transparent, clear solution. Concurrently, 1 g of Li₂SO₄ was dissolved in another 20 mL of deionized water in a separate container. Once dissolved, this Li₂SO₄ solution was combined with the PVA solution. Following this, 2 g of ionic liquid (IL) (1-butyl-3-methylimidazolium ((BMIM) OTf) was added to the mixture. The combined solution was continuously stirred until it reduced to approximately half of its original volume, becoming a sticky solution. This resultant solution was then poured into a glass petri dish. The dish was subjected to multiple cycles of freezing and thawing, leading to the formation of a free-standing, transparent, and flexible gel electrolyte. For comparative purposes, a PVA-Li₂SO₄ gel electrolyte without the IL was also prepared using a similar methodology. Detailed steps for preparation of the gel electrolyte are illustratively represented in FIG. 1B.

### Example 3: Preparation of Date Stone Activated Carbon (DSAC)

Preparation of date stone activated carbon (DSAC) was conducted as per the methodology outlined in the art [Shuaibu, D. A. et al., High-performance Supercapacitors Enabled by Highly-porous Date Stone-derived Activated Carbon and Organic Redox Gel Electrolyte, Asian J. Org. Chem., 2023, 12, which is incorporated herein by reference in its entirety]. The process commenced with pre-carbonization of date stone powder. The powder then underwent an activation process using KOH. Following activation, the material was subjected to a heat treatment at a temperature of 850° C. Heating was conducted in an inert atmosphere, adhering to controlled heating and cooling rates of 10° C./min and 5° C./min, respectively, and was maintained for a duration of 3 hours. Post-heating, the carbon material was thoroughly washed with a 0.5 molar (M) HCl solution, which served to eliminate any residual KOH. The step was succeeded by an additional washing using deionized water to ensure complete removal of impurities. The carbon was dried in an oven over 24 hours to achieve dryness and consistency for further use.

### Example 4: Fabrication of the Supercapacitor Device

Fabrication of the supercapacitor began with the preparation of electrodes. The process involved creating an ink by mixing DSAC, carbon black, and PVDF in a ratio of 7.5:1.5:1. NMP solvent was used to blend these components. The mixture was then subjected to magnetic stirring for one hour, resulting in a uniformly distributed slurry. The homogeneous slurry was subsequently spread onto a stainless-steel substrate. The amount of slurry applied, known as the mass loading, was carefully controlled to be approximately 0.7 milligrams per square centimeter (mg/cm²). Once spread, the electrodes were dried in an electric oven at 80° C. overnight, ensuring they were adequately prepared for the next phase of the supercapacitor fabrication. For the assembly of the supercapacitor, the DSAC electrodes were utilized as both positive and negative electrodes. The PVA-Li₂SO₄-IL gel electrolyte was then integrated with the electrodes. The complete assembly was encapsulated within CR2032-type coin cells to finalize the supercapacitor's fabrication.

### Example 5: Characterization

Surface structure and morphology of the gel electrolyte was characterized using field emission scanning electron microscopy (FESEM, Japan Electron Optics Laboratory Co., Ltd (JOEL), JSM6610LV). Crystal structure was studied at room temperature using X-ray diffraction (XRD, Rigaku Miniflex-II diffractometer). Thermal properties of the gel electrolyte were investigated using thermogravimetric analysis (TGA) and differential scanning calorimetry (DSC). An SDR Q600 thermal analysis instrument was employed for TGA analysis. A simultaneous thermal analysis (STA) 449F3 thermal analysis instrument by NETZSCH was used for DSC analysis. Nanoindentation (Anton Paar STEP 500 Indentation Measurement System, Switzerland) was employed to investigate mechanical strength of the gel electrolyte. All electrochemical characterizations were conducted using a CHI 760E electrochemical workstation.

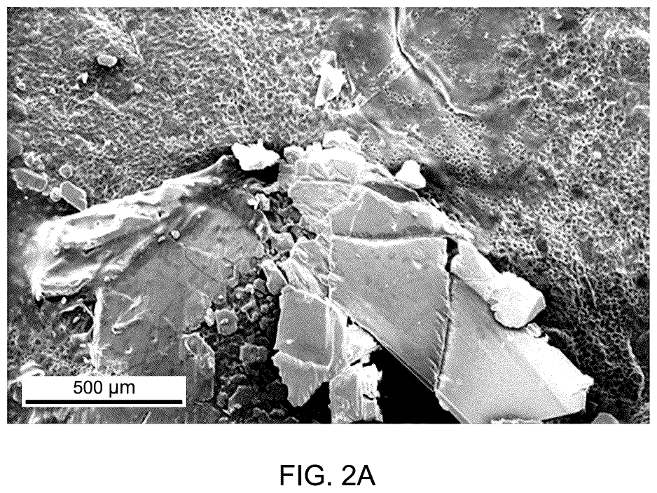

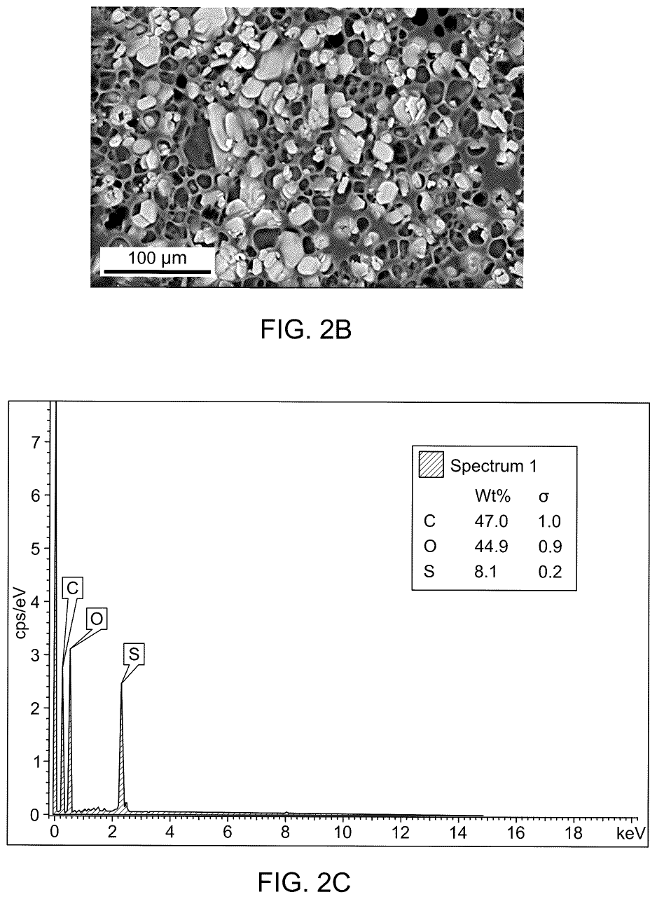

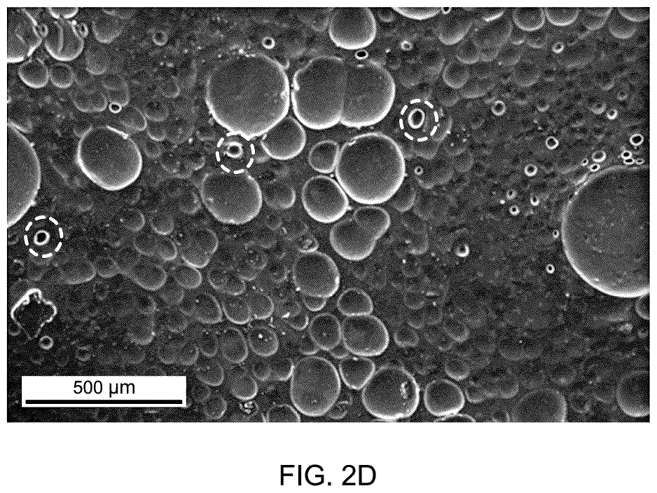

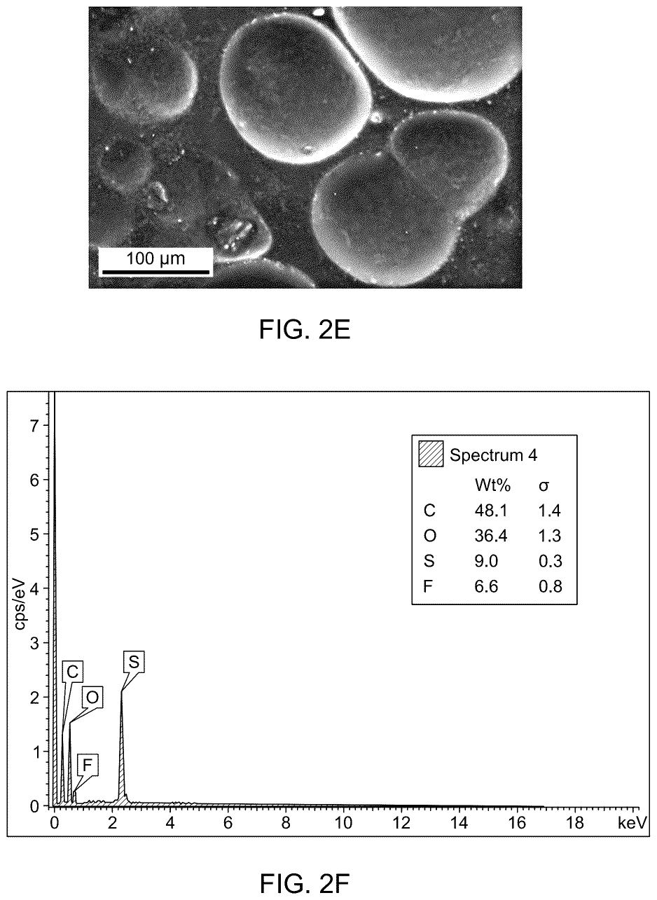

Surface morphology of the two electrolytes, PVA-Li₂SO₄ and PVA-Li₂SO₄-IL, was compared using FESEM. FIGS. 2A-2B depict FESEM images of the PVA-Li₂SO₄ gel electrolyte. The Li₂SO₄ particles display agglomeration within the polymer matrix, suggesting a poor interaction between the polymer and the salt. The uneven dispersion of Li₂SO₄ particles can be attributed to the adhesive properties of PVA. Introducing an ionic liquid (IL) into the system alters the microstructure of the gel electrolyte. The IL functions as a plasticizer, enhancing the miscibility between the polymer and other components in the gel electrolyte. This effect may arise from the formation of multiple hydrogen bonds between PVA chains and IL molecules. The PVA-Li₂SO₄-IL gel electrolyte, as depicted in FIGS. 2D-2E, exhibits a more homogenous microstructure with less agglomeration and uniform pore distribution. The pore diameter and wall thickness were measured using ImageJ software, revealing an average pore diameter of approximately 25 micrometers (μm) and an average wall thickness of around 8 μm. FIG. 2C displays an energy dispersive x-ray spectroscopy (EDS) spectrum of the PVA-Li₂SO₄ gel electrolyte, revealing its carbon, oxygen, and sulfur composition. The primary constituent in the gel electrolyte is carbon, attributed to the presence of PVA. Sulfur is present due to the inclusion of Li₂SO₄, while oxygen is detected in both PVA and Li₂SO₄. In the EDS spectra of the PVA-Li₂SO₄-IL gel electrolyte, shown in FIG. 2F, fluorine is observed in addition to carbon, oxygen, and sulfur. Fluorine is attributed to incorporating the IL in the gel electrolyte.

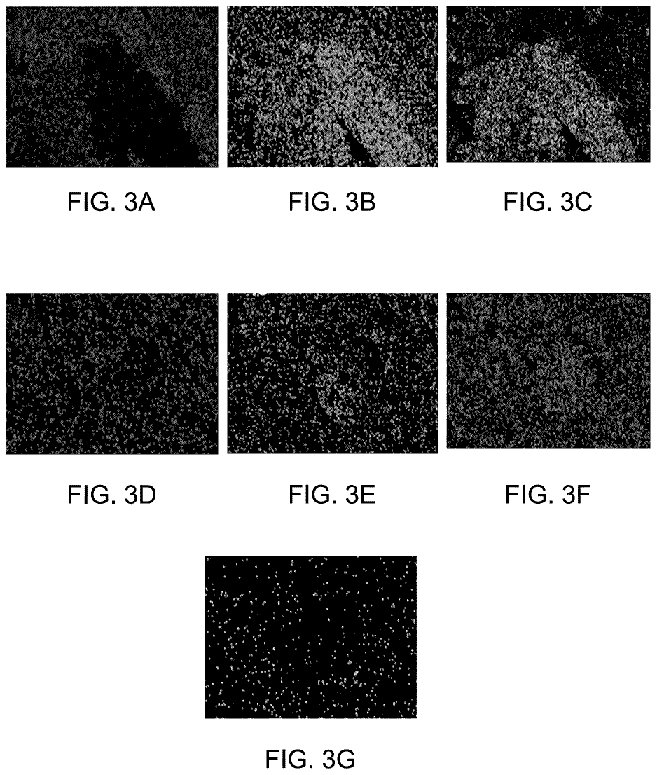

To investigate the physical role of the IL in the gel electrolyte, elemental mapping using EDS (FIGS. 3A-3G) was employed. As illustrated in FIGS. 3A-3B, carbon and oxygen display a uniform distribution throughout the surface of the PVA-Li₂SO₄ gel electrolyte. In contrast, sulfur exhibits agglomeration on one side. In the case of the PVA-Li₂SO₄-IL gel electrolyte (FIGS. 3D-3G), all constituent atoms (carbon, oxygen, sulfur, and fluorine) are uniformly dispersed due to the plasticizing effect of the IL, which further supports the findings from the FESEM analysis.

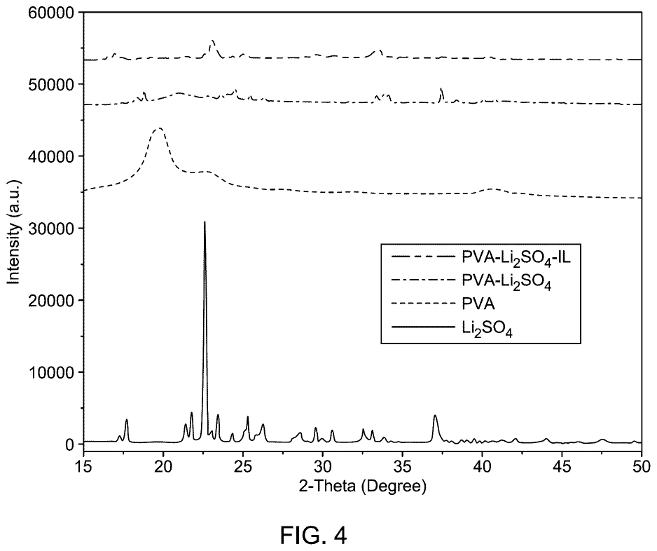

Gel polymer electrolytes (GPEs) exhibit both crystalline and amorphous phases, which originate from the pure polymer's inherent crystalline/amorphous phases and the presence of the crystalline salt. To probe structural information of the gel electrolytes, XRD was employed. FIG. 4 represents the XRD spectra of Li₂SO₄, PVA, PVA-Li₂SO₄, and PVA-Li₂SO₄-IL gel polymer electrolyte. Li₂SO₄ shows several peaks with the most prominent peaks at 2-theta (2θ) of about 17.5°, 22.5°, and 37°, which correspond to the (001), (111), and (201) crystallographic planes of the Li₂SO₄ crystal lattice, respectively. The XRD pattern of PVA displays a broad hump or scattering continuum, typically in the range of 20 of about 15-30°. This diffuse scattering arises from the amorphous arrangement of PVA chains, which lack long-range periodicity. This broad hump becomes broader when Li₂SO₄ is added to the system and disappears completely when IL is further introduced. Introducing an IL into the system alters the microstructure of the gel electrolyte. The IL functions as a plasticizer, enhancing the miscibility between the polymer and other components in the gel electrolyte. This effect may arise from the formation of multiple hydrogen bonds between PVA chains and IL molecules; therefore, not only does IL change the morphology of the gel electrolyte as seen from FESEM data but also causes some microstructural alterations as well.

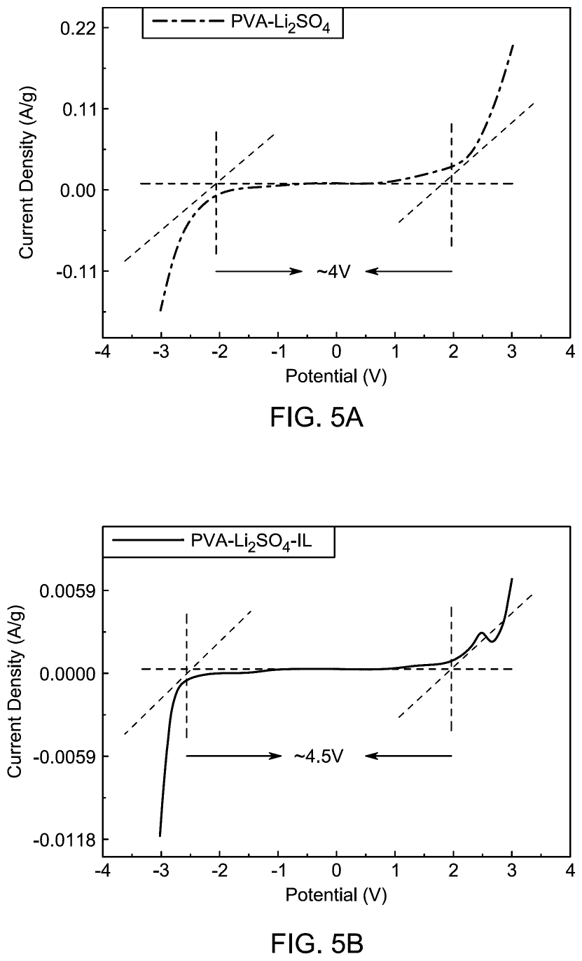

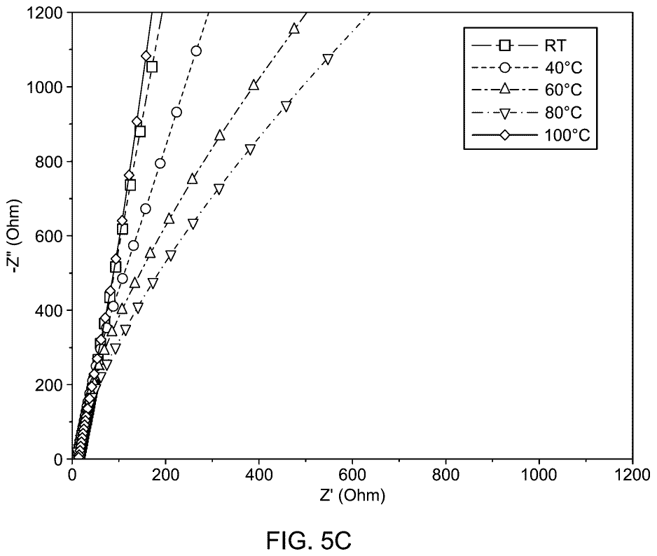

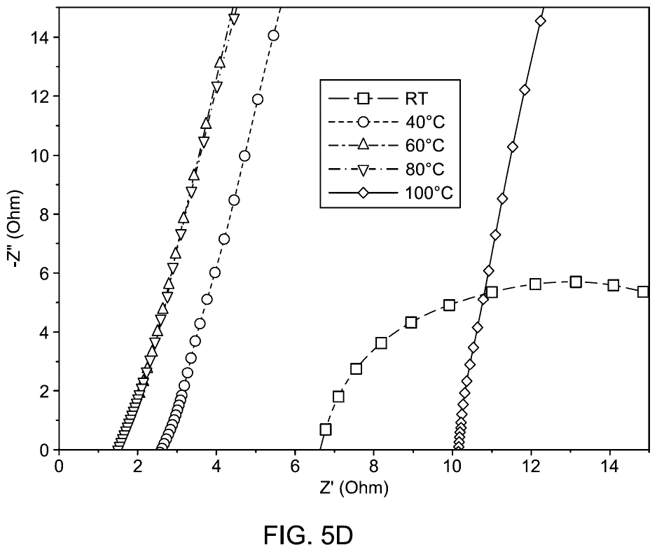

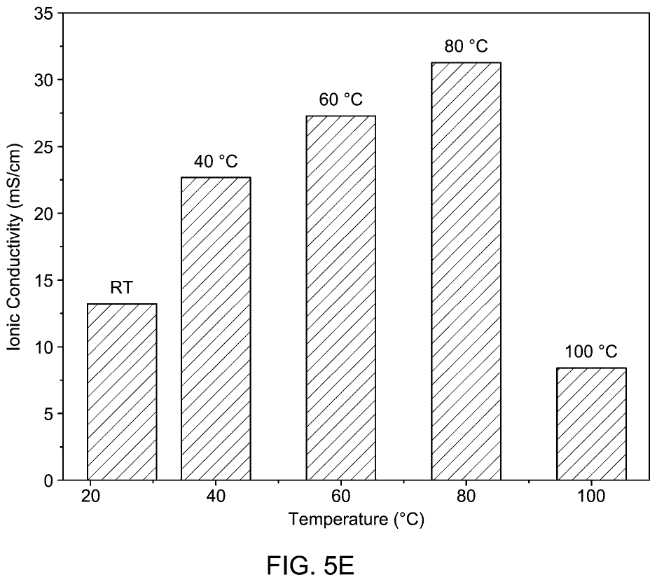

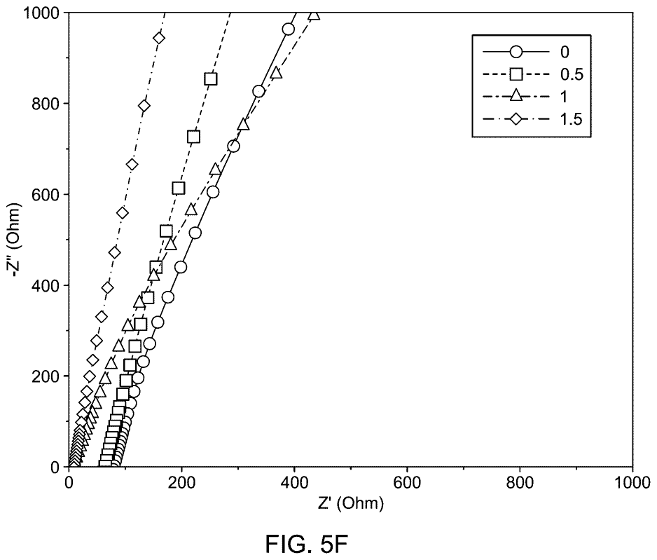

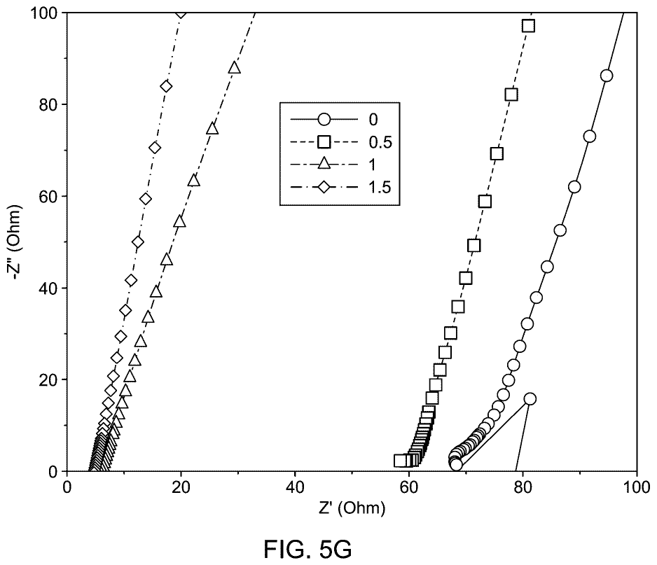

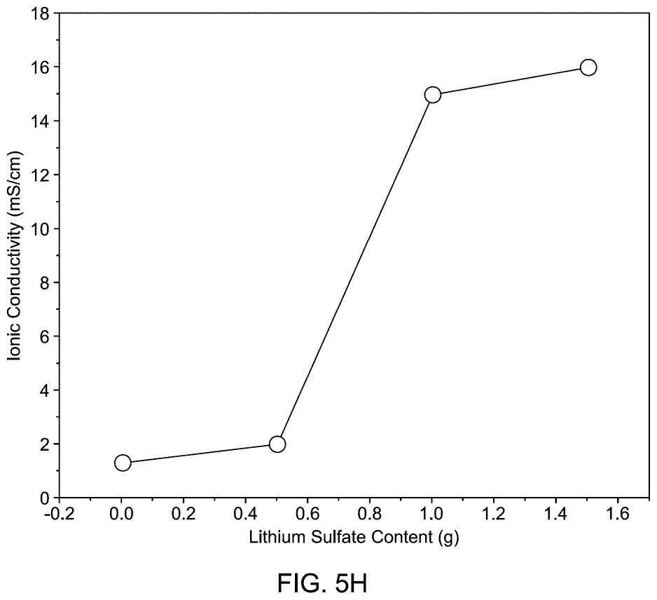

Ionic conductivity plays a role in the performance of gel electrolytes, in which high ionic conductivity is favored for energy storage devices. To ensure that the synthesized gel electrolyte functions in a wide range of temperatures, a 1 square centimeter (cm²) gel electrolyte was pressed between two stainless steel spacers, coupled into a CR2032-type coin cell format, and subjected to electrochemical impedance spectroscopy (EIS) analysis to measure ionic conductivity at different temperature settings. EIS plots of PVA-Li₂SO₄-IL at different temperatures are shown in FIGS. 5C-5D. FIG. 5E depicts a graph of ionic conductivity of the PVA-Li₂SO₄-IL gel electrolyte at different temperatures. Ionic conductivity was calculated according to the equation: σ_{T}=1/R_{b}A, where σ_{T} is the total ionic conductivity of the electrolyte, 1 is the thickness of the gel electrolyte, A is the contact surface area of the gel electrolyte, and Re represents the electrolyte bulk resistance, which can be obtained from the intercept on the real axis of Nyquist plot. FIG. 5E shows that ionic conductivity increases as the temperature increases, attaining the highest value of 31.42 milliSiemens per centimeter (mS/cm) at 80° C. The observed increase in ionic conductivity with rising temperature may be attributed to an underlying mechanism that at lower temperatures, the mobility of ions and segmental motions of polymer chains are constrained due to strong associations between salt and polymer. In contrast, at higher temperatures, the ionic conductivity increases due to a reduction in salt-polymer associations and an enhancement in thermal segmental motion of polymer chains. This results in complex behavior, in which when the polymer is heated to a higher temperature (100° C.), there is a large drop in ionic conductivity of the electrolyte. The drop may be attributed to the polymer's glass transition, which occurs at approximately 96.62° C. The transition is associated with the relaxation process of the glass transition (T_{g}) and arises from the micro-Brownian motion of the polymer chain backbone. The effect of Li₂SO₄ content on the ionic conductivity of the gel electrolyte was investigated. FIGS. 5F and 5G depict EIS Nyquist plots as a function of Li₂SO₄ content. FIG. 5H depicts ionic conductivity as a function of Li₂SO₄ content. Ionic conductivity increases as the concentration of Li₂SO₄ is increased. At higher concentrations of Li₂SO₄, there are more ions available in the solution. As a result, there is a higher probability of ions moving and carrying charge, leading to enhanced ionic conductivity.

Two-electrode system linear sweep voltammetry (LSV) was conducted to determine the operating potential window (OPW) of the electrolyte. The OPW serves as a parameter for electrolytes, delineating the maximum operational voltage limit for electrochemical energy storage devices such as batteries and supercapacitors. FIGS. 5A-5B depict linear sweep voltammograms of PVA-Li₂SO₄ and PVA-Li₂SO₄-IL conducted at a scan rate of 100 millivolts per second (mV/s) from −3 to 3 volts (V). The OPW was determined to be approximately 4 V and 4.5 V for PVA-Li₂SO₄ and PVA-Li₂SO₄-IL, respectively, indicating high stability of both electrolytes. The electrolytes remain free from decomposition at high potentials, addressing a drawback of aqueous-based electrolytes.

An Anton Paar nanoindenter was used for the nanoindentation test. A Berkovich indenter was employed to analyze the gel electrolyte's deformation characteristics and mechanical properties. Experimental parameters are summarized in Table 1.

TABLE 1
Experimental parameters for nanoindentation test

| | Maximum load | Loading rate | Unloading rate | Holding time |
|---|---|---|---|---|
| Indenter | (mN) | (mN/min) | (mN/min) | (s) |
| Berkovich | 50 | 100 | 100 | 10 |

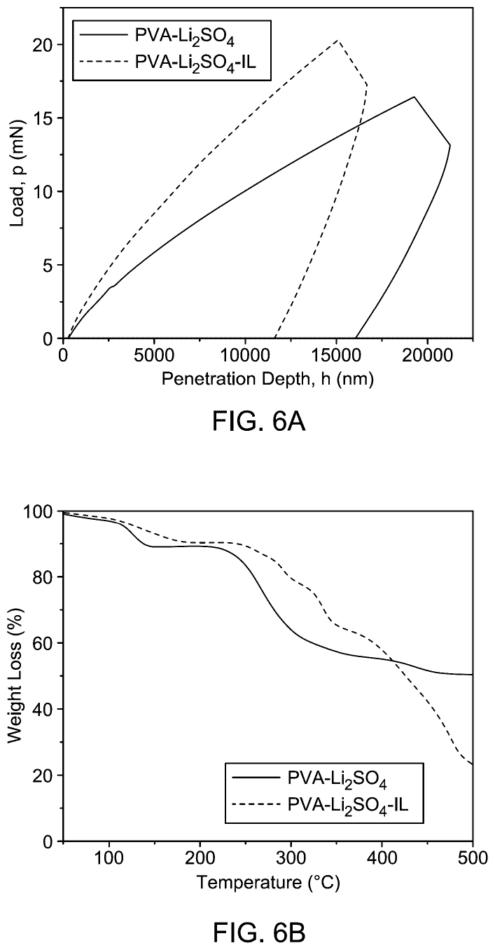

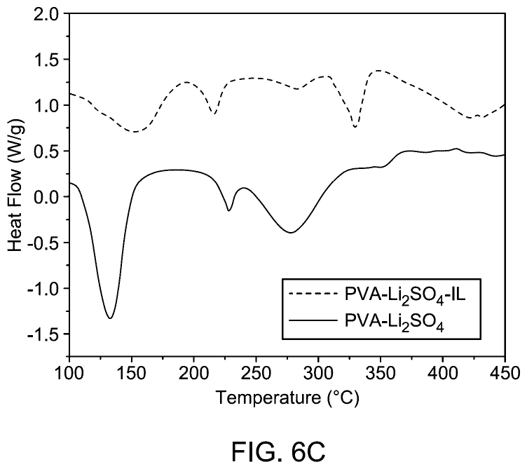

Samples were loaded at a constant displacement rate of 100 milliNewtons per minute (mN/min) to ensure consistent measurements and avoid strain-hardening effects. In the case of PVA-Li₂SO₄, the load increment continued until the indenter reached a depth of ~19,000 nanometers (nm) into the surface. In PVA-Li₂SO₄-IL, the penetration is ~15,000 nm, indicating improvement in hardness of the material. To prevent creep that could impact the unloading behavior, the load was held at its maximum value of 50 mN for 10 seconds. Subsequently, the indenter was gradually withdrawn from the surface at the same rate until the maximum load reached a value of zero. The nanoindentation loading-unloading curve is shown in FIG. 6A. The nanoindentation hardness and the elastic modulus of the gel electrolytes were calculated according to equations 1 and 2, respectively. PVA-Li₂SO₄-IL achieved a nanoindentation hardness of 2.7 megapascals (MPa) and an elastic modulus of 0.057 gigapascals (GPa). PVA-Li₂SO₄ achieved a nanoindentation hardness of 2 MPa and an elastic modulus of 0.035 GPa.

$$H = \frac{{P}_{m ax}}{{A}_{c}} \qquad ( 1 )$$

$$E = \frac{{E}_{i} ( 1 - {V}^{2} )}{\frac{2 β \sqrt{{A}_{c}} {E}_{i}}{S \sqrt{x}} ( 1 - {V}^{2} )} \qquad ( 2 )$$

$$S = \frac{dP}{dh} = 2 β {E}_{r} \sqrt{\frac{A}{π}} \qquad ( 3 )$$

where H is the hardness, Pₘₐₓ is the maximum load, A_{c} is the contact area between the indenter and the specimen, E is the elastic modulus of the sample, Eᵢ is the elastic modulus of the indenter, V is the poisons ratio of the sample, Vᵢ is the poisons ratio of the indenter, β is a geometric constant of the indenter, and S is the stiffness which is the slope of the initial unloading curve. In the present disclosure, V=0.3, Eᵢ=1141 GPa, and Vᵢ=0.07. β=1.034 for the Berkovich indenter.

FIG. 6B depicts TGA, which was employed to investigate the thermal stability of gel electrolytes. The analysis was conducted in a temperature range of 25 to 800° C. and at a heating rate of 10° C./minute. The evaporation of water can be attributed to the weight loss observed in the gel electrolytes within the temperature range of 30 to 192° C. According to FIG. 6B, the PVA-Li₂SO₄ gel electrolyte shows a degradation in the range of 200 to 300° C. and remains with a reduced degradation rate up to 500° C. The PVA-Li₂SO₄-IL shows higher stability up to around 400° C. and then the degradation rate is accelerated. This further degradation observed when IL is introduced into the system is associated with the degradation temperature of the IL, which is around 400° C. The synthesized gel electrolyte can be applied at high temperatures up to 150° C. with minimal degradation compared to the PVA-Li₂SO₄ gel electrolyte.

The DSC thermogram of the gel electrolytes is displayed in FIG. 6C. The melting temperature of the PVA-Li₂SO₄ was observed at ~216° C., which increased to ~228° C. in case of PVA-Li₂SO₄-IL. This enhancement in melting temperature can be attributed to a strong interaction between the PVA-Li₂SO₄ and IL. Although the glass transition temperature (T_{g}) of pure PVA is ~96.2° C. [Khan, M. S. and Shakoor, A., Ionic conductance, thermal and morphological behavior of PEO-graphene oxide-salts composites, J. Chem., 2015, 695930, which is incorporated herein by reference in its entirety], the PVA-Li₂SO₄ shows enhanced T_{g} at ~130° C. This has further been enhanced to ~150° C. in the case of PVA-Li₂SO₄-IL. Changes in the DSC thermograms of gel electrolytes, such as enhancement in the melting and glass transition temperatures, indicate the strength of salt-polymer interactions.

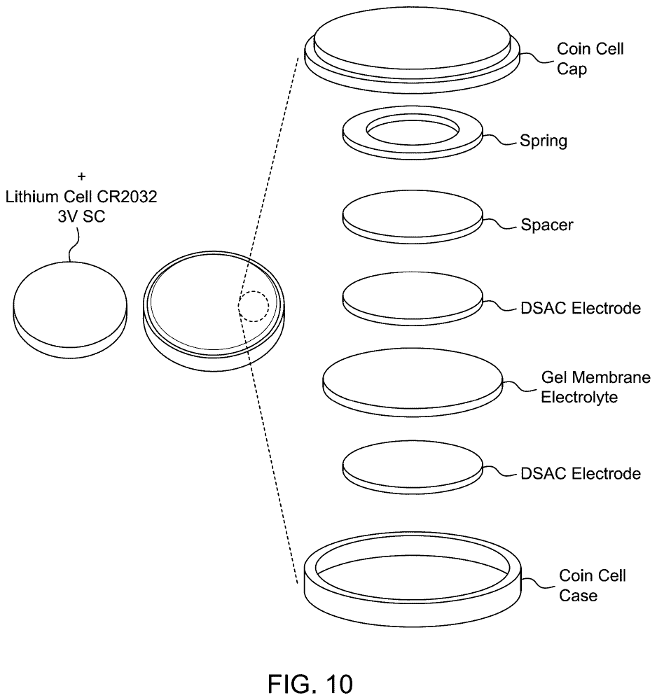

Two supercapacitor devices were assembled, each utilizing a different gel electrolyte: one with a PVA-Li₂SO₄ gel electrolyte and the other incorporating a PVA-Li₂SO₄-IL gel electrolyte. In both devices, the gel electrolytes served dual roles as both separators and electrolytes. The electrodes, made from DSAC coated on stainless steel, functioned as both positive and negative electrodes. To assemble the supercapacitor, the DSAC electrodes and the respective gel electrolytes were placed into a CR2032-type coin cell casing. Once positioned, the assembly was securely crimped using an MSK-160E electric crimper, thus forming a symmetric supercapacitor device. The entire assembly process and the structure of the supercapacitor are clearly illustrated in FIG. 10.

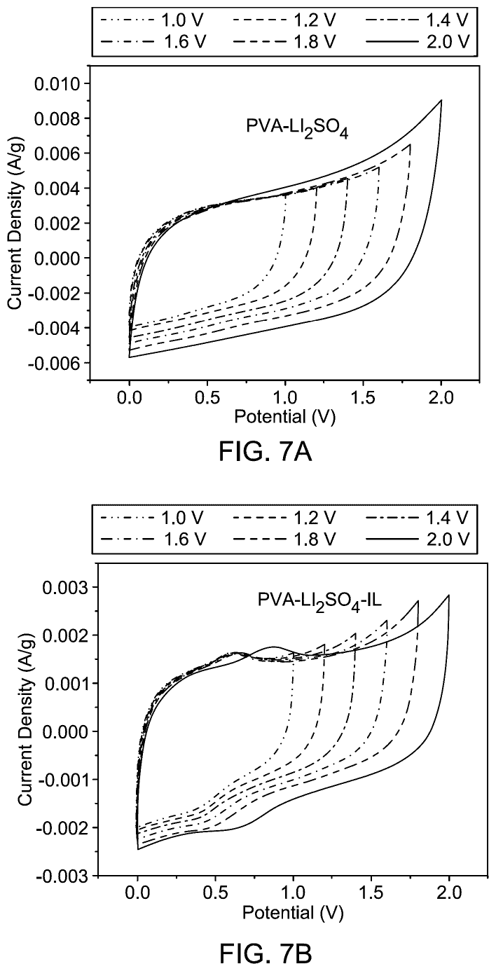

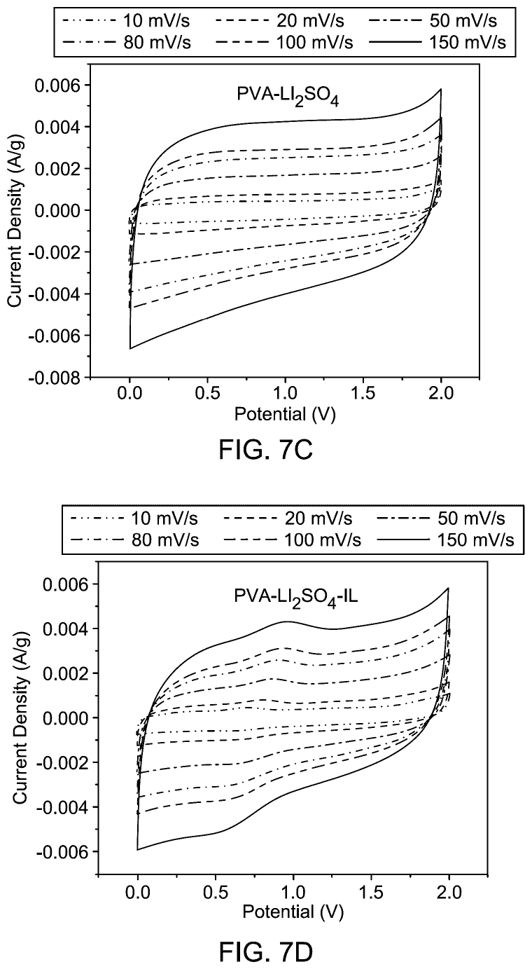

Before assessing the electrochemical performance of the supercapacitor devices (also referred to as symmetric semiconductor devices and devices), their maximum OPW was investigated. Initially, cyclic voltammetry (CV) was conducted at different OPWs at a constant scan rate of 50 mV/s. FIGS. 7A-7B depict cyclic voltammograms (CVs) of the supercapacitor devices with PVA-Li₂SO₄ and PVA-Li₂SO₄-IL gel electrolytes at different OPWs ranging from 0 to 2 V. CVs of both devices displayed quasi-rectangular shapes without water oxidation peaks up to 2 V. This value is greater than the OPW of the aqueous electrolytes. Thus, the obtained gel electrolyte is suitable for high-energy-density applications. CVs were also recorded at different scan rates ranging from 10 to 150 mV/s to assess the stability of the fabricated devices further. CVs of the symmetric semiconductor devices at different scan rates and an OPW of 2 V are displayed in FIGS. 7C-7D. CVs of the PVA-Li₂SO₄-IL-based device show a pair of oxidation-reduction (redox) peaks due to the inclusion of IL. The appearance of redox peaks promotes pseudo-capacitance, which is in addition to electric double-layer capacitance (EDLC). Charge and discharge mechanisms involve complex interactions between the electrolyte components and the activated carbon electrodes. During charging, lithium ions (Li⁺) from Li₂SO₄ and anions from 1-butyl-3-methylimidazolium trifluoromethanesulfonate (IL) migrate towards the oppositely charged electrodes. Li⁺ ions adsorb onto the negative electrode, forming an electric double layer, while IL anions adsorb at the positive electrode. The presence of IL enhances charge storage due to improved ion transport and adsorption. During discharge, Li⁺ ions and IL anions desorb from the electrodes and recombine in the electrolyte, allowing electron flow from the positive to the negative electrode, generating an electric current. Other factors may be responsible for the observed redox peaks, including the interaction between nitrogen functional groups found in the IL, —C═O functional groups in the electrode materials, —C—O⁻ functional groups present in the PVA with Li⁺ ions in the salt, and/or interaction between impurities. N/O-rich functional groups in the system can cause reversible pseudo-capacitance represented by a pair of redox peaks observed in the CV. Mechanisms for the observed redox reaction are given in equations 4 through 6.

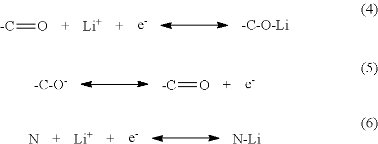

From the CVs in FIGS. 7A-7B, specific capacitances at different OPWs were calculated based on the area under the curve for both devices using equation 7.

$${C}_{s} = \frac{\int I \times Δ V}{m \times v \times Δ V} \qquad ( 7 )$$

∫I×ΔV represents area under the CV, measured in watts, m denotes the average mass of the active material present on both electrodes, expressed in grams, ν refers to the scan rate, which is quantified in volts per second (V/s), and ΔV represents the OPW, measured in volts.

Specific capacitance at OPWs of 1 V, 1.2 V, 1.4 V, 1.6 V, 1.8 V, and 2 V was found to be 33 farads per gram (F/g), 34.4 F/g, 35.4 F/g, 37.5 F/g, 39.1 F/g, and 43.1 F/g, respectively, for the PVA-Li₂SO₄-based symmetric supercapacitor. For the PVA-Li₂SO₄-IL-based symmetric supercapacitor, the specific capacitance is 70 F/g, 71.4 F/g, 72.4 F/g, 74.1 F/g, 77.6 F/g, and 82.6 F/g at OPWs of 1 V, 1.2 V, 1.4 V, 1.6 V, 1.8 V, and 2 V, respectively. Specific capacitances at different scan rates were also evaluated from the CVs (FIGS. 7C-7D) of both devices. Specific capacitances from the CVs were 112.69 F/g, 98.17 F/g, 82.48 F/g, 75.19 F/g, 71.6 F/g, and 64.91 F/g at the scan rates of 10 mV/s, 20 mV/s, 50 mV/s, 80 mV/s, 100 mV/s, and 150 mV/s, respectively, for the PVA-Li₂SO₄-IL-based supercapacitor. Specific capacitances of the PVA-Li₂SO₄-based device were calculated from the CVs and were 58.55 F/g, 49.6 F/g, 43.13 F/g, 34.54 F/g, 30.99 F/g, and 29.38 F/g at scan rates of 10 mV/s, 20 mV/s, 50 mV/s, 80 mV/s, 100 mV/s, and 150 mV/s, respectively.

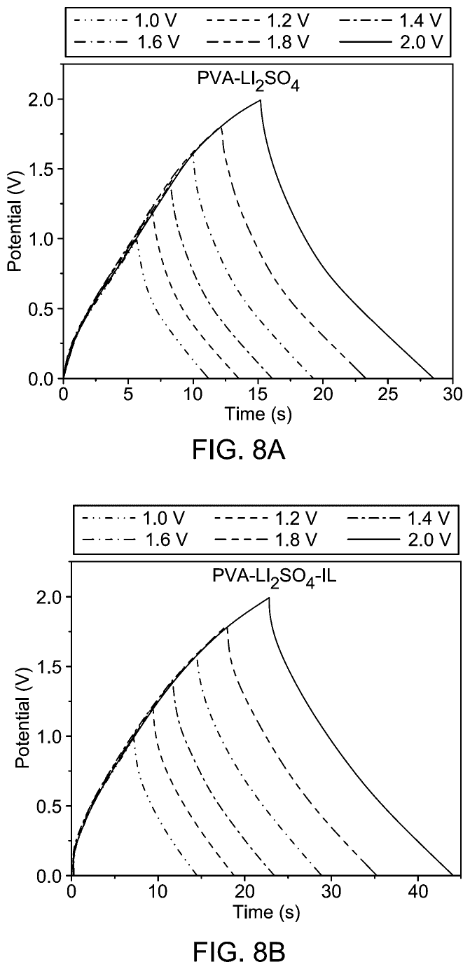

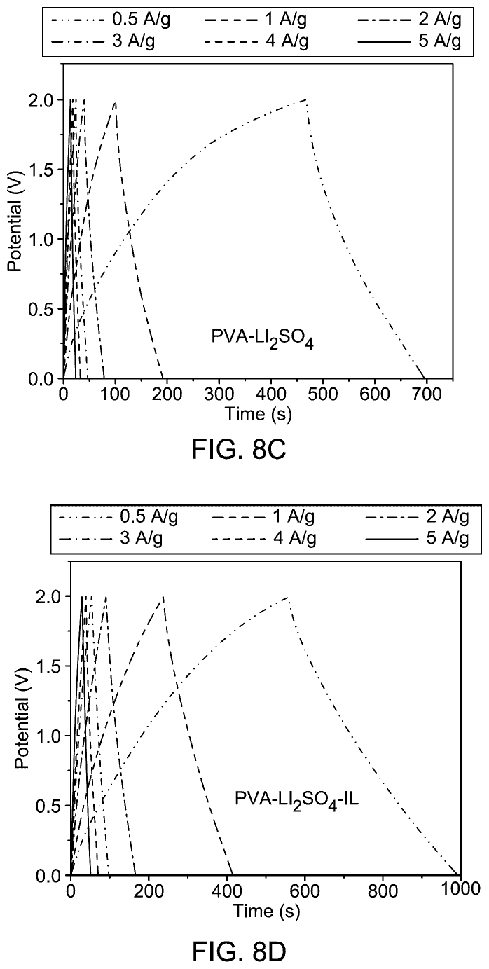

Galvanostatic charge-discharge (GCD) at different OPWs and constant current densities were investigated to evaluate electrochemical performance of the supercapacitors. GCD cycles of both devices were stable up to 2 V, which is displayed in FIGS. 8A-8B. FIGS. 8C-8D depict GCD curves of PVA-Li₂SO₄-based and PVA-Li₂SO₄-IL-based supercapacitors, respectively, at different current densities. The GCD curves exhibited almost symmetric triangular shapes without apparent internal resistance (IR) drops, indicating a rapid charge-discharge process and a typical EDLC behavior. Both devices show robust performance. In the symmetric supercapacitors, redox peaks observed in CV but absent in GCD highlight the electrochemical behaviors captured by these techniques. CV, with its potential sweep, is sensitive to faradaic processes such as redox reactions, seen in the observed redox peaks. GCD, operating under constant current, emphasizes capacitive (non-faradaic) mechanisms, seen in the triangular GCD curves, indicative of charge storage through electrostatic accumulation rather than redox reactions. This difference underscores the varying responses of electrode materials and electrolytes under different testing conditions. The specific capacitance, energy, and power of the fabricated devices were calculated from the GCD results using equations 8 through 10.

$$C ( \text{F/g} ) = \frac{I \times Δ t}{m \times Δ V} \qquad ( 8 )$$

$$E ( Wh \text{/kg} ) = \frac{1}{2} \frac{C \times Δ {V}^{2}}{3.6} \qquad ( 9 )$$

$$P ( \text{W/kg} ) = \frac{E \times 3600}{t} \qquad ( 10 )$$

where I is the applied current, Δt is the discharge time, m is the mass of the active material on both electrodes, ΔV is the operating voltage window, C is the specific capacitance, E is the energy density, and P is the power density.

Specific capacitance was calculated from the device's discharge time and the electrode material's total active mass using equation 9. Specific capacitance was calculated at different OPWs and a constant current density of 5 amperes per gram (A/g) for both devices using the data in FIGS. 8A-8B. The specific capacitances for the PVA-Li₂SO₄-based device were 27.55 F/g, 27.63 F/g, 27.75 F/g, 28.98 F/g, 31.08 F/g, and 33.29 F/g at OPWs of 1 V, 1.2 V, 1.4 V, 1.6 V, 1.8 V, and 2 V, respectively. Specific capacitances of the PVA-Li₂SO₄-IL-based supercapacitor at OPWs of 1 V, 1.2 V, 1.4 V, 1.6 V, 1.8 V, and 2 V were 36.08 F/g, 39.09 F/g, 41.39 F/g, 44.49 F/g, 48.01 F/g, and 57.5 F/g, respectively. Specific capacitances at different current densities for both devices from the GCD curves in FIGS. 8C-8D were evaluated. The PVA-Li₂SO₄-based device showed a maximum specific capacitance of 56.75 F/g at 0.5 A/g and 30 F/g at a high current density of 5 A/g. Introducing IL into the PVA-Li₂SO₄ system imposes pseudo capacitance and increases the capacitive properties of the device. The specific capacitance was calculated from the GCD profile of the PVA-Li₂SO₄-IL-based supercapacitor and was found to be as high as 117.25 at 0.5 A/g (about 210% of the capacitance of a pure PVA-Li₂SO₄-based device) and remains high at high current density, with a value of 57.5 F/g at 5 A/g.

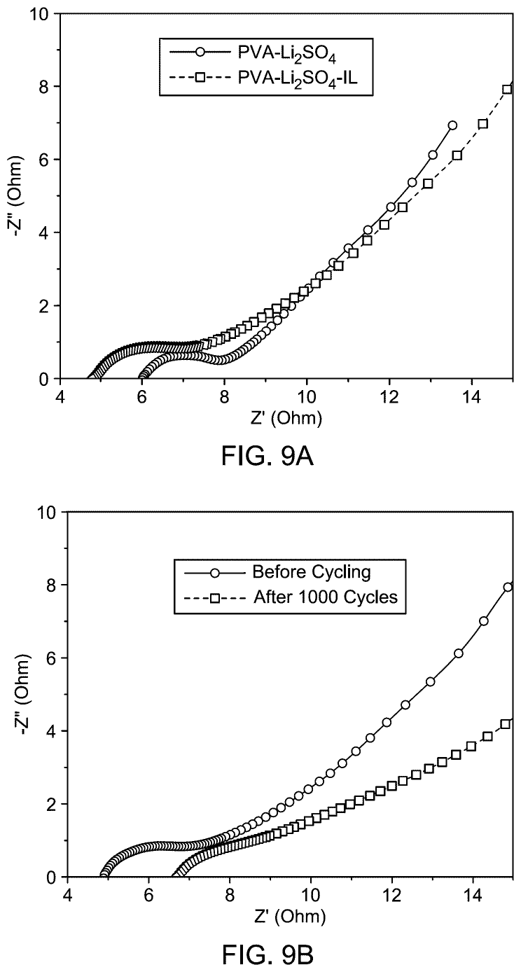

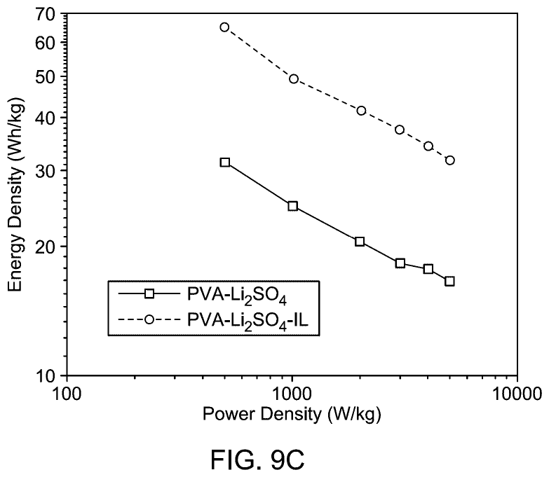

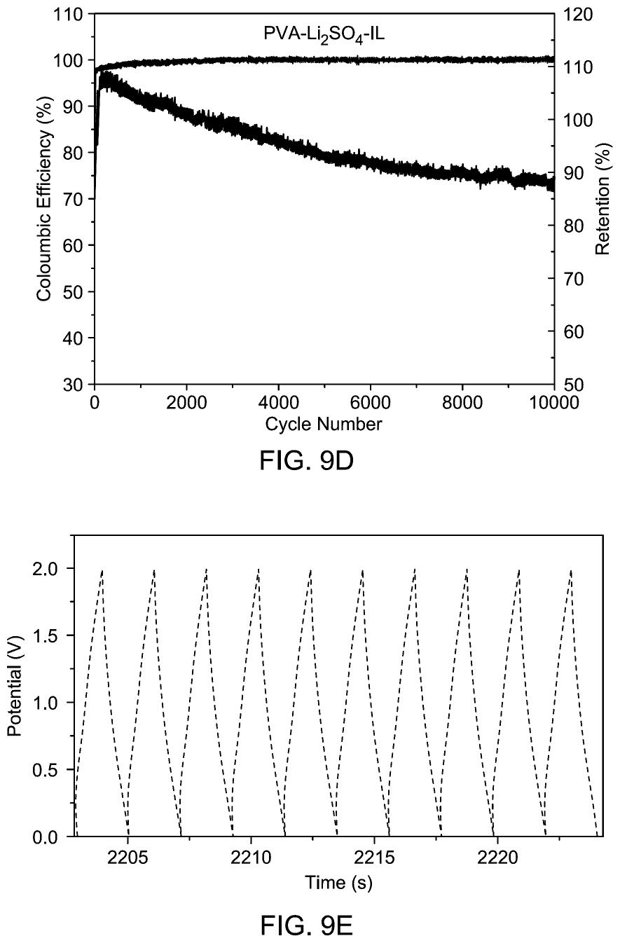

To gain an understanding of the electrochemical interface properties of the supercapacitor devices, EIS was utilized. FIG. 9A compares the Nyquist plot of the PVA-Li₂SO₄-based and PVA-Li₂SO₄-IL-based symmetric supercapacitor devices. The bulk resistance of the supercapacitor, which includes the electrolyte resistance and internal electrode resistance, is represented by the intercept point on the real axis at the high-frequency region. Charge transfer resistance can be determined by the diameter of the compressed semicircle. As seen in FIG. 9A, including an IL reduces the bulk resistance from 6 ohms (Ω) to 4.9Ω, as indicated by the intercept on the real axis of the Nyquist plot. FIG. 9B depicts the Nyquist plot for the PVA-Li₂SO₄-IL-based device before and after 1000 cycles. An increase in resistance (from 4.9Ω to 6.8Ω) after prolonged cycling at high current density is observed. This increase can be attributed to the degradation of the electrolyte caused by the high current applied during the stability test; however, this degradation is negligible. From FIG. 9B, it is observed that incorporating an IL into the PVA-Li₂SO₄ system enhances the efficiency of the fabricated device, even after extended cycling.

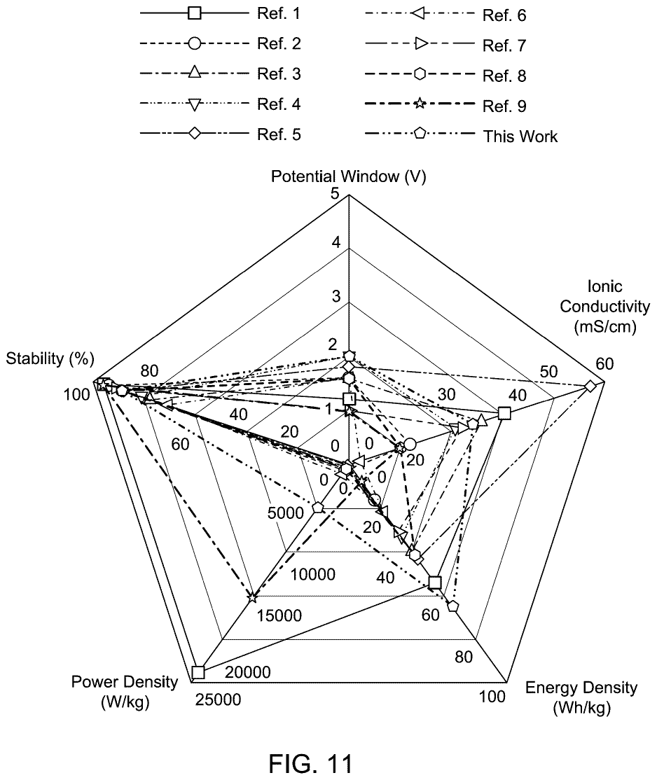

Energy density and power density are two parameters of supercapacitors that would limit their application. As shown in FIG. 9C, both the energy density and the power density decrease with the increase of current density, which is a common trend for supercapacitors. According to equations 9 and 10, the maximum energy density attained by the PVA-Li₂SO₄-IL-based device is 65.15 watt-hours per kilogram (Wh/kg) at 500 watts per kilogram (W/kg). The PVA-Li₂SO₄-based device achieves an energy density of 31.5 Wh/kg under the same conditions. FIGS. 9D-9E depict cycling stability of the PVA-Li₂SO₄-IL-based supercapacitor under a current load of 10 A/g for 10,000 GCD cycles. The results demonstrate that promising cycle stability is achieved at a current load of 10 A/g. After 10,000 GCD cycles, the capacitance retention was 88.7%. Coulombic efficiency is close to 100%, suggesting high cycling stability and a high degree of charge-discharge reversibility. Table 2 shows the electrochemical performance comparison of the developed symmetric supercapacitor with previously reported similar supercapacitors in the art. FIG. 11 shows a radar chart summarizing and comparing potential windows, ionic conductivity, energy density, power density, and capacitance retention reported literature.

TABLE 2
Comparison of the electrochemical performance of the symmetric
supercapacitor device with reported literature

| | | Ionic | Energy | Power | | |
|---|---|---|---|---|---|---|
| | | conductivity | density | density | Stability | |
| Electrolyte | OPW (V) | (mS/cm) | (Wh/kg) | (W/kg) | (%/cycles) | Ref. |
| PVA- | 1.2 | 39.3 | 54.3 | 23880 | 96/3000 | 1 |
| H₃PO₄- | | | | | | |
| [EMIM]BF₄ | | | | | | |
| PVA-Li₂SO₄ | 1.5 | 46 | 29.3 | . . . | 80.9/10000 | 2 |
| BMIMI | | | | | | |
| PVA/Na₂SO₄ | . . . | . . . | 20.42 | 799.9 | 84.5/3000 | 3 |
| PVA- | 1.6 | 15.2 | 16.3 | 932.6 | 93.4/10000 | 4 |
| LiBr- | | | | | | |
| [BMIM]Cl | | | | | | |
| PVA- | 1.6 | 33.3 | 39.4 | 400 | 78/1000 | 5 |
| H₂SO₄- | | | | | | |
| ARS | | | | | | |
| PVA-NaCl | 0.6 | . . . | 6.33 | 600 | 87/8000 | 6 |
| PVA- | 2.0 | 27.1 | 33 | 459.2 | 81/8000 | 7 |
| Na₂SO₄- | | | | | | |
| Pyr₁₄Br | | | | | | |
| PVA- | 1.6 | . . . | 25.4 | 190 | 93.7/1000 | 8 |
| H₂SO₄-KI- | | | | | | |
| VOSO₄ | | | | | | |
| PVA- | 1.8 | 61.1 | 43.1 | 220.9 | 87.9/10000 | 9 |
| LI₂SO₄- | | | | | | |
| EMIMBr- | | | | | | |
| CNT | | | | | | |
| PVA/IL/ | 1.0 | . . . | . . . | 2500 | 95/3000 | 10 |
| H₃PO₄ | | | | | | |
| PVA- | 1.6 | 2.82 | 22 | 1080 | 70.4/5000 | 11 |
| HMIMCl- | | | | | | |
| KOH | | | | | | |
| PVA/BMI | 1.5 | 37 | 10.6 | | 90/3000 | 12 |
| MCl/Li₂SO₄ | | | | | | |
| PVA- | 1.0 | 28.5 | 30.5 | 350 | 91/1000 | 13 |
| H₂SO₄-AQQS | | | | | | |
| PVA/Na₂SO₄ | 2.0 | . . . | 0.92 mWh/cm³ | 28.6 mW/cm³ | 85/4000 | 14 |
| PVA/LiClO₄ | . . . | . . . | 41 | 2100 | 95/2500 | 15 |
| PVA-LiCl | 1.8 | . . . | 184.5 μWh/cm² | 0.92 mW/cm² | 90/10000 | 16 |
| PVA-KOH-KI | 1.6 | 13.21 | 41.308 | 464.72 | 89.3/5000 | 17 |
| PVA- | 1.0 | 12.73 | 7.8 | 15340 | 95.76/1000 | 18 |
| KOH-KI | | | | | | |
| PVA-LiClO₄ | 1.8 | . . . | 11.63 | 4890 | 85.5/4000 | 19 |
| PVA- | 2.0 | 31.42 | 65.14 | 5000 | 88.7/10000 | This work |
| Li₂SO₄-IL | | | | | | |

1 refers to Seok Jang, H. et al., Enhanced supercapacitive performances of functionalized activated carbon in novel gel polymer electrolytes with ionic liquid redox-mediated poly(vinyl alcohol)/phosphoric acid, RSC Adv., 2016, 6, 75376-75383; 2 refers to Tu, Q.-M., et al., Design of a novel redox-active gel polymer electrolyte with a dual-role ionic liquid for flexible supercapacitors, Electrochim. Acta, 2018, 268, 562-568; 3 refers to Li, Z. et al., A quasi-solid asymmetric supercapacitor based on MnO2-coated and N-doped pinecone porous carbon, J. Mater. Sci. Mater. Electron, 2022, 33, 1899-1909; 4 refers to Tang, X. et al., Redox-Active Hydrogel Polymer Electrolytes with Different pH Values for Enhancing the Energy Density of the Hybrid Solid-State Supercapacitor, ACS Appl. Mater. Interfaces, 2017, 9, 44429-44440; 5 refers to Sun, K. et al., High energy density of quasi-solid-state supercapacitor based on redox-mediated gel polymer electrolyte, RSC Adv., 2016, 6, 55225-55232; 6 refers to Le, P. A. et al., Food seasoning-derived gel polymer electrolyte and pulse-plasma exfoliated graphene nanosheet electrodes for symmetrical solid-state supercapacitors, RSC Adv., 2022, 12, 1515-1526; 7 refers to Geng, C. L. et al., High energy density and high working voltage of a quasi-solid-state supercapacitor with a redox-active ionic liquid added gel polymer electrolyte, New J. Chem., 2019, 43, 18935-18942; 8 refers to Fan, L.-Q. et al., Improving the energy density of quasi-solid-state electric double-layer capacitors by introducing redox additives into gel polymer electrolytes, J. Mater. Chem. A., 2014, 2, 9011; 9 refers to Fan, L. Q. et al., High energy density and low self-discharge of a quasi-solid-state supercapacitor with carbon nanotubes incorporated redox-active ionic liquid-based gel polymer electrolyte, Electrochim. Acta, 2020, 331, 135425; 10 refers to Lee, K. S. et al., Capacitive behavior of functionalized activated carbon-based all-solid-state supercapacitor, Carbon Lett., 2021, 31, 1041-1049; 11 refers to Tian, Z. et al., High rate capability electrode constructed by anchoring CuCo2S4 on graphene aerogel skeleton toward quasi-solid-state supercapacitor, Electrochim. Acta, 2019, 298, 321-329; 12 refers to Zhang, X. et al., A Flexible Ionic Liquid Gelled PVA-Li2SO4 Polymer Electrolyte for Semi-Solid-State Supercapacitors, Adv. Mater. Interfaces, 2015, 2, 1500267; 13 refers to Feng, E. et al., Toughened redox-active hydrogel as flexible electrolyte and separator applying supercapacitors with superior performance, RSC Adv., 2016, 6, 75896-75904; 14 refers to Shao, W. et al., High-performance cobalt-doped carbon cloth supported porous Fe2O3 flexible electrode material in quasi-solid asymmetric supercapacitors, J. Alloys Compd., 2022, 929, 167141; 15 refers to Chodankar, N. R. et al., Bendable All-Solid-State Asymmetric Supercapacitors based on MnO2 and Fe2O3 Thin Films, Energy Technol., 2015, 3, 625-631; 16 refers to Shi. F. et al., N/S co-doped carbon nanosheets derived from sugarcane processing by-products for flexible solid-state supercapacitors, J. Electroanal. Chem., 2023, 932, 117217; 17 refers to Kim, M. and Kim, J., Redox active KI solid-state electrolyte for battery-like electrochemical capacitive energy storage based on MgCo2O4 nanoneedles on porous β-polytype silicon carbide, Electrochim. Acta., 2018, 260, 921-931; 18 refers to Yu, H. et al., Improvement of the performance for quasi-solid-state supercapacitor by using PVA-KOH-KI polymer gel electrolyte, Electrochim. Acta., 2011, 56, 6881-6886; and 19 refers to Pandit, B. et al., The electrochemical kinetics of cerium selenide nano-pebbles: The design of a device-grade symmetric configured wide-potential flexible solid-state supercapacitor, Nanoscale Adv., 2021, 3, 1057-1066, which are incorporated herein by references in their entireties.

In the present disclosure a high-energy-density supercapacitor comprising a PVA-Li₂SO₄-IL gel electrolyte and DSAC electrodes is described. The PVA-Li₂SO₄-IL gel electrolyte, synthesized through a solution casting method, demonstrated high ionic conductivity, reaching a peak value of 31.42 mS/cm at 80° C. The symmetric supercapacitor, constructed using the gel electrolyte, achieved greater performance metrics compared to bare PVA-Li₂SO₄, including an energy density of 65.14 Wh/kg at a power density of 500 W/kg. The assembled supercapacitor using PVA-Li₂SO₄-IL exhibited high cycling stability, maintaining 88.7% capacitance retention and approximately 100% coulombic efficiency after 10,000 cycles. These results underscore the efficacy of the PVA-Li₂SO₄-IL gel electrolyte in enhancing the electrochemical performance of energy storage devices and open avenues for its application across various electrochemical fields. The potential of ionic liquid usage in gel electrolyte development encourages the development of next-generation safe and high-energy density energy storage systems.

Numerous modifications and variations of the present disclosure are possible in light of the above teachings. It is, therefore, to be understood that within the scope of the appended claims, the disclosure may be practiced otherwise than as specifically described herein.

1: A gel electrolyte, comprising:
a polyvinyl alcohol;
lithium sulfate; and
a 1-butyl-3-methylimidazolium trifluoromethanesulfonate,
wherein the gel electrolyte is porous having an average pore diameter of 20 to 30 μm and an average pore wall thickness of 5 to 10 μm,
wherein the gel electrolyte comprises spherical nodules having a diameter of 5 to 500 μm.

2: The gel electrolyte of claim 1, wherein the gel electrolyte is made by a process comprising:
dissolving the polyvinyl alcohol in water to form a first solution;
dissolving the lithium sulfate in water to form a second solution;
mixing the first solution and the second solution to form a third solution;
mixing the 1-butyl-3-methylimidazolium trifluoromethanesulfonate with the third solution at a temperature of 80 to 100° C. for 1 to 3 hours to form a mixture; and
freezing and thawing the mixture to form the gel electrolyte.

3: The gel electrolyte of claim 2, wherein a weight ratio of the polyvinyl alcohol to the lithium sulfate to the 1-butyl-3-methylimidazolium trifluoromethanesulfonate is 1-3:0.5-1.5:1-3.

4: The gel electrolyte of claim 1, wherein the gel electrolyte comprises carbon in an amount of 46 to 50 percent by weight (wt. %), oxygen in an amount of 34 to 38 wt. %, sulfur in an amount of 6 to 12 wt. %, and fluorine in an amount of 5 to 8 wt. % based on a total weight of the gel electrolyte.

5: The gel electrolyte of claim 1, wherein the gel electrolyte has a nanoindentation hardness of 2.4 to 3 MPa.

6: The gel electrolyte of claim 1, wherein the gel electrolyte has an elastic modulus of 0.04 to 0.08 GPa.

7: The gel electrolyte of claim 1, wherein the gel electrolyte has a glass transition temperature of 140 to 160° C.

8: The gel electrolyte of claim 1, wherein the gel electrolyte has an ionic conductivity of 12 to 15 mS/cm at a temperature of 25° C.

9: The gel electrolyte of claim 1, wherein the gel electrolyte has an ionic conductivity of 29 to 34 mS/cm at a temperature of 80° C.

10: A symmetric supercapacitor, comprising:
a positive electrode and a negative electrode comprising a date stone activated carbon mixture coated on stainless steel; and
the gel electrolyte of claim 1,
wherein the gel electrolyte separates the positive electrode and the negative electrode,
wherein the positive electrode, the gel electrolyte, and the negative electrode are enclosed in a coin cell.

11: The symmetric supercapacitor of claim 10, wherein the symmetric supercapacitor has an operating potential window of 4.3 to 4.7 V.

12: The symmetric supercapacitor of claim 10, wherein the symmetric supercapacitor has a specific capacitance of 80 to 85 F/g over an operating potential window of 2 V via cyclic voltammetry.

13: The symmetric supercapacitor of claim 10, wherein the symmetric supercapacitor has a specific capacitance of 110 to 115 F/g at a scan rate of 10 mV/s via cyclic voltammetry.

14: The symmetric supercapacitor of claim 10, wherein the symmetric supercapacitor has a specific capacitance of 115 to 120 F/g at a current density of 0.5 A/g via galvanostatic charge/discharge tests.

15: The symmetric supercapacitor of claim 10, wherein the symmetric supercapacitor has a specific capacitance of 55 to 60 F/g at a current density of 5 A/g via galvanostatic charge/discharge tests.

16: The symmetric supercapacitor of claim 10, wherein the symmetric supercapacitor has a bulk resistance of 4.5 to 5.5 ohms.

17: The symmetric supercapacitor of claim 10, wherein the symmetric supercapacitor has a bulk resistance of 6.5 to 7 ohms after 1000 charge and discharge cycles.

18: The symmetric supercapacitor of claim 10, wherein the symmetric supercapacitor has an energy density of 60 to 70 Wh/kg at a power density of 500 W/kg.

19: The symmetric supercapacitor of claim 10, wherein the symmetric supercapacitor has a capacitance retention of 85 to 90% of an initial capacitance after 10,000 galvanostatic charge/discharge cycles at a current load of 10 A/g.

20: The symmetric supercapacitor of claim 10, wherein the symmetric supercapacitor has a coulombic efficiency of at least 98% after 10,000 galvanostatic charge/discharge cycles at a current load of 10 A/g.
